(19) United States
(12) Patent Application Publication
(10) Pub. No.: US 2025/0271358 A1
(43) Pub. Date: Aug. 28, 2025

(54) SYSTEM AND PHOTONIC CRYSTAL FIBER-BASED SURFACE PLASMON RESONANCE SENSOR TO DETECT REFRACTIVE INDEX OF ANALYTE

(71) Applicant: KING FAHD UNIVERSITY OF PETROLEUM AND MINERALS, Dhahran (SA)

(72) Inventors: Khurram Karim QURESHI, Dhahran (SA); Sheikh Sharif Iqbal MITU, Dhahran (SA); Asad Muhammad BUTT, Dhahran (SA)

(73) Assignee: KING FAHD UNIVERSITY OF PETROLEUM AND MINERALS, Dhahran (SA)

(21) Appl. No.: 18/589,707

(22) Filed: Feb. 28, 2024

(51) Int. Cl. G01N 21/41; G02B 6/02

(52) U.S. Cl. CPC G01N 21/4133; G02B 6/02323; G01N 2021/4153; G01N 2201/0846; G01N 2201/088

(57) ABSTRACT

A photonic crystal fiber-based surface plasmon resonance (PCF-SPR) sensor to detect a refractive index of an analyte includes a fiber core having a first scale-down (SCD) cavity having a first diameter, multiple second SCD cavities each having a second diameter, multiple third SCD cavities each having a third diameter, and a groove. A surface of the groove is coated with a metal having a first thickness. The sensor includes an analyte channel having a second thickness and is in contact with the metal. The analyte channel surrounds the fiber core and is configured to stream the analyte. The sensor further includes an outer layer surrounding the analyte channel. The refractive index of the analyte is detected based on an intensity lost by an incident light passing through the PCF-SPR sensor due to dissipation of plasmonic energy.

### STATEMENT REGARDING PRIOR DISCLOSURE BY THE INVENTORS

Aspects of this technology are described in an article “U-Grooved Selectively Coated and Highly Sensitive PCF-SPR Sensor for Broad Range Analyte RI Detection”, published in IEEE Access, which is incorporated herein by reference in its entirety.

### STATEMENT OF ACKNOWLEDGEMENT

This research was supported by King Fahd University of Petroleum and Minerals (KFUPM), Dhahran, Saudi Arabia. The inventors acknowledge the Deanship of Research Oversight and Coordination. Inventor Khurram Karim Qureshi would also like to acknowledge the support provided by Interdisciplinary Research Center for Communication Systems and Sensing through project no. INCS2303.

### BACKGROUND

### Technical Field

The present disclosure is directed to a sensor for detecting the refractive index of an analyte, more particularly directed to a photonic crystal fiber-based surface plasmon resonance (PCF-SPR) sensor to detect the refractive index of the analyte and a method of measuring refractive index of an analyte.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Surface plasmon resonance (SPR) is a well-known and well-established method for detecting refractive index (RI) (See: B. Han et al., “High-sensitive fiber anemometer based on surface plasmon resonance effect in photonic crystal fiber”, IEEE Sensors J., vol. 19, no. 9, pp. 3391-3398 May 2019). In contrast to prism-based SPR sensors, which have bulky systems, configurational structures with limited wavelengths, and waveguides with V-grooves, the photonic crystal fiber based surface plasmon resonance (PCF-SPR) sensors have gained popularity due to several significant advantages, such as high precision, accessibility, real-time, and label-free sensing properties (See: E. K. Akowuah, et al., “Numerical analysis of a photonic crystal fiber for biosensing applications”, IEEE J. Quantum Electron., vol. 48, no. 11, pp. 1403-1410 November 2012). Additionally, optical fiber is given priority over the conventional type SPR sensors, as an excellent option for cheap and miniaturized sensors to drive the surface plasmon polaritons (SPP) modes. Noticeably, the freedom offered by PCF to synthesize the optical variables, arrangeable geometry of formation, and manageable birefringence, makes it useful for a broad range of sensing capabilities (See: F. Haider et al., “Alphabetic-core assisted microstructure fiber based plasmonic biosensor”, Plasmonics, vol. 15, no. 6, pp. 1949-1958 July 2020). A lot of research has been reported using PCF-based SPR sensing technology, since they may be extensively implemented in diverse sensing fields, such as living organisms, and chemical and biological substances. Wide detection range, adjustable dispersion, high-level integration, excellent propagation, miniature size, and extremely sensitive properties are some of the fundamental benefits of using PCF-SPR based sensors. Mostly gold (Au), silver (Ag), copper (Cu), aluminium (Al), palladium (Pd), and bismuth (Bi) play a significant role as the plasmonic materials in the PCF-SPR based sensing techniques. Au exhibits stability in chemical processes due to its resonant peak variation than other plasmonic materials (See: J. Homola et al., “Surface plasmon resonance sensors based on diffraction gratings and prism couplers: Sensitivity comparison”, Sens. Actuators B, Chem., vol. 54, nos. 1-2, pp. 16-24, January 1999). Typically, single analyte type PCF-SPR sensors have been reported. In a study, an external type D-shaped PCF sensor is developed, utilizing Au/Ge₂Sb₂Te₅ as a sensing layer for the detection of individual analyte, where optimum wavelength sensitivity (WS) for crystalline and amorphous phases are 17,600 nm/RIU and 8,000 nanometers per refractive index unit (nm/RIU), respectively. In another study, a single analyte type sensor is disclosed that achieved highest WS of 2,000 nm/RIU and optimized for the analyte refractive index (RI) range from 1.33 to 1.35. In yet another study, an external sensing technique using a PCF sensor is introduced that achieved a maximum WS and amplitude sensitivity (AS) of 20,000 nm/RIU and 1380 RIU⁻¹, respectively. In yet another study, a multi-analyte PCF sensor with internal coating having a peak WS of 18,000 nm/RIU is disclosed (See: Jahan et al. “Photonic crystal fiber based biosensor for pseudomonas bacteria detection: A simulation study”, IEEE Access, vol. 9, pp. 42206-42215, 2021). In yet another study, PCF-SPR-based sensor design is disclosed, which was optimized for the refractive index in the range of 1.385 to 1.40 and produced a maximum wavelength sensitivity of 10,000 nm/RIU (See: Kaur et al., “Design of titanium nitride coated PCF-SPR sensor for liquid sensing applications”, Opt. Fiber Technol., vol. 48, pp. 159-164, March 2019). In yet another study, a titanium coated external type individual sample biosensor with WS of 10000 nm/RIU for x-polarization is disclosed (See: Jabin et al., “Surface plasmon resonance based titanium coated biosensor for cancer cell detection”, IEEE Photon. J., vol. 11, no. 4, pp. 1-10, August 2019). In another study, a PCF sensor is disclosed that was optimized for RI in the range 1.42 to 1.46 and exhibited the maximum WS and AS of 15000 nm/RIU and 230 RIU⁻¹, respectively (See: Hossain et al., “Numerical development of high performance quasi D-shape PCF-SPR biosensor: An external sensing approach employing gold”, Results Phys., vol. 18, September 2020, Art. no. 103281). In another study, a PCF-SPR-based sensor design is disclosed, which was optimized for the refractive index in the range of 1.385 to 1.40 and produced a maximum wavelength sensitivity of 10,000 nm/RIU. In another study, a structure is disclosed that was optimized for RI covering 1.14-1.36 and with optimum AS and figure of merit (FOM) values of 328 RIU⁻¹ and 105 RIU⁻¹, respectively (See: Anik et al., “Milled microchannel-assisted open D-channel photonic crystal fiber plasmonic biosensor”, IEEE Access, vol. 9, pp. 2924-2933, 2021). A circular shaped PCF sensor was designed in another study, which exhibited the highest WS and resolution of 2000 nm/RIU and 5×10⁻⁵ RIU, respectively (See: Dash et al., “SPR biosensor based on polymer PCF coated with conducting metal oxide”, IEEE Photon. Technol. Lett., vol. 26, no. 6, pp. 595-598, March 2014).

All the proposed sensors mentioned above are implemented by either using internal or external techniques. In case of the internal sensing technique, the internal surface coating of selective holes with plasmonic materials that is usually 1 to 2 micrometers (μm) thick infiltrate the liquid that make this technique slightly complex during the fabrication. On the other hand, in case of the external type sensing technique, the complexity in the internal type sensing approach could be overcome even though sometimes this technique may depict less sensitivity due to long distance interaction between core and plasmonic layers (See: C. Caucheteur et al., “Review of plasmonic fiber optic biochemical sensors: Improving the limit of detection, Anal. Bioanal. Chem., vol. 407, no. 14, pp. 3883-3897 May 2015”). Hence, a need remains to develop a PCF based SPR sensor to improve the maximum coupling outcome between plasmonic and the elemental modes by optimizing the forming factors such as cavities pitch, diameter, ring lattice setting, as well as the selection of plasmonic materials.

Each of the aforementioned prior arts suffers from one or more drawbacks hindering their adoption. Therefore, it is one object of the present disclosure to provide a photonic crystal fiber-based surface plasmon resonance (PCF-SPR) sensor to detect broad range RI of bio-samples.

### SUMMARY

In an exemplary embodiment, a photonic crystal fiber-based surface plasmon resonance (PCF-SPR) sensor to detect a refractive index of an analyte is disclosed. The PCF-SPR sensor includes a fiber core having a first scale-down (SCD) cavity having a first diameter, a plurality of second SCD cavities each having a second diameter, a plurality of third SCD cavities each having a third diameter, and a groove. Further, a surface of the groove is coated with a metal having a first thickness. The first SCD cavity, the plurality of second SCD cavities, the plurality of third SCD cavities, and the groove extend axially along the fiber core. Furthermore, the PCF-SPR sensor includes an analyte channel having a second thickness. The analyte channel surrounds the fiber core and is in contact with the metal. The analyte channel is further configured to stream the analyte. The sensor further includes an outer layer surrounding the analyte channel. The refractive index of the analyte is detected based on an intensity lost by an incident light passing through the PCF-SPR sensor due to dissipation of a plasmonic energy.

In some embodiments, the groove is U-shaped.

In some embodiments, the first diameter is smaller than the second diameter, and the second diameter is smaller than the third diameter.

In some embodiments, the first SCD cavity is located in a center of the fiber core and is configured to facilitate a phase matching of an elementary core mode with a plurality of surface-plasmon-polariton (SPP) modes.

In some embodiments, the plurality of second SCD cavities surrounds the first SCD cavity and the plurality of third SCD cavities surrounds the plurality of second SCD cavities. The plurality of second and third cavities are configured to provide an evanescent field in an interface between the surface of the groove and the metal.

In some embodiments, the first SCD cavity and each of the plurality of second and third SCD cavities are separated by a pitch size. The pitch size is a distance between centers of the nearest neighboring first SCD cavity and each of the nearest neighboring plurality of second and third SCD cavities.

In some embodiments, the PCF-SCR sensor includes six second SCD cavities.

In some embodiments, the metal is gold (Au) and the fiber core is a single-mode fused silica.

In some embodiments, the first thickness is between 40 nanometers (nm) and 50 nm.

In some embodiments, the second thickness is about 1.36 micrometers (μm).

In some embodiments, the pitch size is about 2.2 μm.

In some embodiments, the first diameter is about 0.264 μm, the second diameter is about 0.5 μm, and the third diameter is about 1.76 μm.

In some embodiments, the fiber core consists of a single-mode fused silica except for the surface of the groove which is coated with the metal.

In another exemplary embodiment, a system for identifying an analyte is disclosed. The system includes a light source and a PCF-SPR sensor connected to the light source. The PCF-SPR sensor includes a fiber core having a first SCD cavity having a first diameter, a plurality of second SCD cavities each having a second diameter, a plurality of third SCD cavities each having a third diameter, and a groove. Further, a surface of the groove is coated with a metal having a first thickness. The first SCD cavity, the plurality of second SCD cavities, the plurality of third SCD cavities, and the groove extend axially along the fiber core. Furthermore, the PCF-SPR sensor includes an analyte channel having a second thickness. The analyte channel surrounds the fiber core and is in contact with the metal. The analyte channel is further configured to stream the analyte. The PCF-SPR sensor further includes an outer layer surrounding the analyte channel. The refractive index of the analyte is detected based on an intensity difference between incident light entering the fiber core and the incident light dissipated in the fiber core as plasmonic energy. Moreover, the system includes an optical spectrum analyzer connected to the PCF-SPR sensor, and a computer connected to the optical spectrum analyzer. The computer is configured to analyze a loss curve obtained by the optical spectrum analyzer to identify the analyte.

In some embodiments, the groove is U-shaped.

In some embodiments, the first diameter is smaller than the second diameter, and the second diameter is smaller than the third diameter.

In some embodiments, the first SCD cavity is located in a center of the fiber core and is configured to facilitates a phase matching of an elementary core mode with a plurality of surface-plasmon-polariton (SPP) modes.

In some embodiments, the plurality of second SCD cavities surrounds the first SCD cavity and the plurality of third SCD cavities surrounds the plurality of second SCD cavities. The plurality of second and third cavities are configured to provide an evanescent field in an interface between the surface of the groove and the metal.

In some embodiments, the first SCD cavity and each of the plurality of second and third SCD cavities are separated by a pitch size. The pitch size is a distance between centers of the nearest neighboring first SCD cavity and each of the nearest neighboring plurality of second and third SCD cavities.

In some embodiments, the system includes six second SCD cavities.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic block diagram of a system for detecting a refractive index (RI) of an analyte, according to certain embodiments.

FIG. 2A is a schematic cross-sectional view of a photonic crystal fiber-based surface plasmon resonance (PCF-SPR) sensor of the system of FIG. 1, according to certain embodiments.

FIG. 2B is a schematic diagram of a stacked preform structure of a fiber core of the PCF-SPR sensor, according to certain embodiments.

FIG. 3A is a graph depicting confinement loss and amplitude sensitivity (AS) for indium-tin-oxide (ITO) as a plasmonic material, according to certain embodiments.

FIG. 3B is a graph depicting confinement loss and AS for gold (Au) as a plasmonic material, according to certain embodiments.

FIG. 4A shows distribution of y-polarized electric fields of core guided mode for the analyte RI of 1.35, according to certain embodiments.

FIG. 4B shows distribution of y-polarized electric fields of surface plasmon polarities (SPP) mode for the analyte RI of 1.35, according to certain embodiments.

FIG. 4C is a graph depicting y-polarized phase-matching conditions at the analyte RI of 1.35, according to certain embodiments.

FIG. 5A is a graph depicting wavelength shift of propagation loss peaks with different RIs of liquid, according to certain embodiments.

FIG. 5B is a graph depicting Birefringence characteristics of the PCF-SPR sensor, according to certain embodiments.

FIG. 6A is a graph depicting amplitude sensitivities, according to certain embodiments.

FIG. 6B is a graph depicting correlation between figure of merit (FOM) and full width at half maximum (FWHM) for variation of sample RI, according to certain embodiments.

FIG. 6C is a graph depicting confinement loss and sensor length, according to certain embodiments.

FIG. 6D is a graph depicting polynom fitting for the PCF-SPR sensor, according to certain embodiments.

FIG. 7A shows light distribution effect of scale-down (SCD) cavities for a sample RI of 1.35 with omitted first (or center) SCD cavity, according to certain embodiments.

FIG. 7B shows light distribution effect of SCD cavities for a sample RI of 1.35 with the first (or the center) SCD cavity and omitted four second SCD cavities from both upper and lower regions, according to certain embodiments.

FIG. 7C shows light distribution effect of SCD cavities for a sample RI of 1.35 with position reversing of the first and second SCD cavities, according to certain embodiments.

FIG. 8A is a graph depicting loss spectrum for miscellaneous depth of gold layer, according to certain embodiments.

FIG. 8B is a graph depicting AS curves for miscellaneous depth of gold layer, according to certain embodiments.

FIG. 8C is a graph depicting resonant wavelength interrogation curve for thickness variation of gold layer, according to certain embodiments.

FIG. 9A is a graph depicting fluctuation of loss spectrum curves for pitch size variation, according to certain embodiments.

FIG. 9B is a graph depicting resonant wavelength interrogation curve for pitch size variation, according to certain embodiments.

FIG. 9C is a graph depicting fluctuation of loss spectrum curves for third SCD cavities diameter variation, according to certain embodiments.

FIG. 9D is a graph depicting resonant wavelength interrogation curve for third SCD cavities diameter variation, according to certain embodiments.

FIG. 10A is a graph depicting fluctuation of loss spectrum curves for second SCD cavities diameter variation, according to certain embodiments.

FIG. 10B is a graph depicting resonant wavelength interrogation curve for second SCD cavities diameter variation, according to certain embodiments.

FIG. 10C is a graph depicting fluctuation of loss spectrum curves for first SCD cavities diameter variation, according to certain embodiments.

FIG. 10D is a graph depicting resonant wavelength interrogation curve for first SCD cavities diameter variation, according to certain embodiments.

FIG. 11A is a graph depicting fluctuation of loss spectrum curves for second SCD cavities diameter variation, according to certain embodiments.

FIG. 11B is a graph depicting resonant wavelength interrogation curve for second SCD cavities diameter variation, according to certain embodiments.

FIG. 12 is an illustration of a non-limiting example of details of computing hardware used in a computer of the system, according to certain embodiments.

FIG. 13 is an exemplary schematic diagram of a data processing system used within the computer, according to certain embodiments.

FIG. 14 is an exemplary schematic diagram of a processor used with the computer, according to certain embodiments.

FIG. 15 is an illustration of a non-limiting example of distributed components which may share processing with a controller of the computer, according to certain embodiments.

### DETAILED DESCRIPTION

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of the present disclosure are directed to a photonic crystal fiber-based surface plasmon resonance (PCF-SPR) sensor and a system including the PCF-SPR sensor to detect and/or measure a refractive index of an analyte. The PCF-SPR sensor uses a U-grooved selective coating for extremely sensitive remote and biosensing applications. Scale-down (SCD) cavities control the light path in such a way that incoming light passes through the PCF-SPR sensor in order to activate the free electrons present therein. The finite element method (FEM) is employed to quantitatively tune the properties of light and sensitivity of the PCF-SPR sensor. The PCF-SPR sensor has maximum amplitude sensitivity (AS) of 1189 RIU⁻¹, highest wavelength sensitivity (WS) of 12,500 nm/RIU, and an outstanding resolution of 8.0×10⁻⁶ RIU. The model covers a large refractive index (RI) range of unknown samples, ranging from 1.29 to 1.40. This range allows the PCF-SPR sensor to cover the detection of a wide range of analytes including, but not limited to, viruses, cancer cells, carbohydrates, proteins, and DNA/RNA.

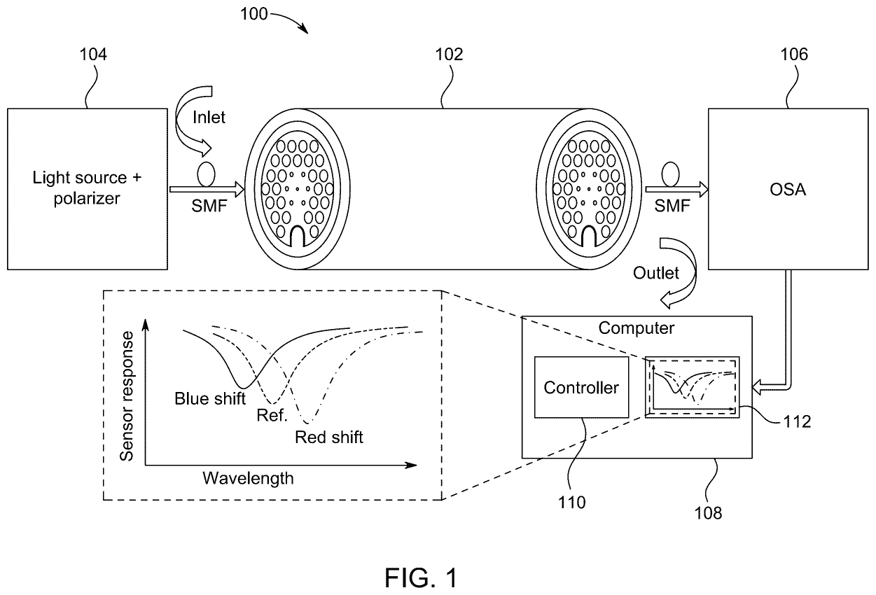

Referring to FIG. 1, a schematic block diagram of a system 100 for identifying an analyte is illustrated, according to an embodiment of the present disclosure. In particular, an experimental set-up for detecting a refractive index (RI) of the analyte is shown in FIG. 1. The system 100 includes a PCF-SPR sensor 102 to detect the refractive index of the analyte. In an embodiment of the present disclosure, an internal type of ring-shaped single analyte biosensing technique is implemented to detect broad range refractive index (RI) of bio-samples. For the internal sensing approach, PCF-SPR sensing technique is used due to its features and outcomes. The PCF-SPR sensor 102 may lower the cost of plasmonic materials and low sensitivity limitations. Passing propagating light through the PCF-SPR sensor 102 causes improved RI sensing. Therefore, the PCF-SPR sensor 102 can be used with high accuracy to detect a broad range of unknown analyte's RI from 1.29 to 1.40. The sensitivity achieved for the wavelength and amplitude interrogation techniques are as high as 12,500 nanometers per refractive index unit (nm/RIU) and 1189 RIU⁻¹, respectively.

The system 100 further includes a light source 104 configured to be in optical communication with the PCF-SPR sensor 102. In other words, the PCF-SPR sensor 102 is connected to the light source 104 to receive light emitted by the light source 104. In an embodiment, a broadband or monochromatic light source may be utilized. As shown in FIG. 1, a transverse magnetic or p-polarized electromagnetic wave is initially transmitted through the PCF-SPR sensor 102 by the light source 104. As a result, the electromagnetic wave gradually loses intensity due to dissipation of plasmonic energy at an interface of the PCF-SPR sensor 102. The maximum power is received by surface plasmon polaritons (SPP) at the resonant wavelength, which is dependent on the RI of specific liquid streaming over a surface of the PCF-SPR sensor 102.

The system 100 further includes an optical spectrum analyzer (OSA) 106 connected to the PCF-SPR sensor 102. The OSA 106 is generally used for measuring optical power of both narrowband and broadband sources as a function of wavelength. In other words, the OSA 106 may quantify and display the power of a light source over a given wavelength range. In some embodiments, a computer-connected photodetector may be implemented with the system 100. The system 100 further includes a computer 108 configured to be in communication with the OSA 106 and configured to analyze a loss curve obtained by the OSA 106 to identify the analyte. In an embodiment, the OSA 106 is employed in order to interpolate and fine-tune the loss curve and compare a response of the PCF-SPR sensor 102 with a pre-trained reference spectrum by a controller 110 of the computer 108. Further, a user-defined decision tree algorithm may indicate the RI of the analyte on a display unit 112 of the computer 108.

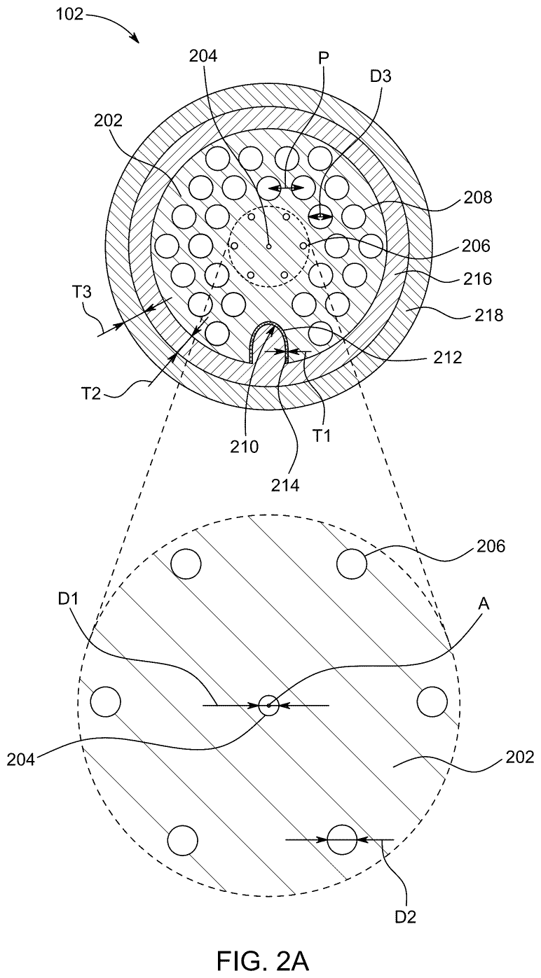

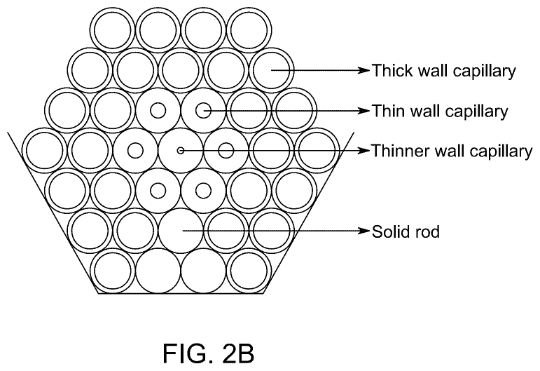

Referring to FIG. 2A, a schematic cross-sectional view of the PCF-SPR sensor 102 is illustrated, according to an embodiment of the present disclosure. The PCF-SPR sensor 102 has a circular cross-section and is designed in the form of a cable. As the PCF-SPR sensor 102 is configured to carry the light throughout a length thereof, the PCF-SPR sensor 102 may be alternatively referred to as an optical cable. The PCF-SPR sensor 102 includes a fiber core 202 configured to transmit optical data signal along the length thereof. Generally, the fiber core 202 is made of continuous strand of glass. The fiber core 202 includes a first scale-down (SCD) cavity 204 located in a center of the fiber core 202. In other words, the first SCD cavity 204 may be defined at a central axis ‘A’ of the PCF-SPR sensor 102. Further, the first SCD cavity 204 may be defined throughout the length of the fiber core 202 along the central axis ‘A’. The SCD cavity may be alternatively referred to as the cavity, and the first SCD cavity 204 may be alternately referred to as the first SCD cavity. The first SCD cavity 204 is configured to facilitate a phase matching of an elementary core mode with a plurality of surface-plasmon-polariton (SPP) modes. The first SCD cavity 204 has a circular cross-section and has a first diameter ‘D1’, which is otherwise referred to as the first SCD cavity diameter.

The fiber core 202 further includes a plurality of second SCD cavities 206 defined around the first SCD cavity 204, and a plurality of third SCD cavities 208 defined around the plurality of second SCD cavities 206. The plurality of second SCD cavities 206 surrounds the first SCD cavity 204 for instigating the birefringence effect. The plurality of second SCD cavities 206 and the plurality of third SCD cavities 208 are defined around the first SCD cavity 204 to define a hexagonal shape. The second SCD cavities 206 and the third SCD cavities 208 may be alternately referred to as the second SCD cavities and the third SCD cavities, respectively. Each of the plurality of second SCD cavities 206 has a second diameter ‘D1’, which is greater than the first diameter ‘D1’ of the first SCD cavity 204. Similarly, each of the plurality of third SCD cavities 208 has a third diameter ‘D3’, which is greater than the second diameter ‘D2’ of the second SCD cavity 206. In other words, the first diameter ‘D1’ of the first SCD cavity 204 is smaller than the second diameter ‘D2’ of the second SCD cavity 206, and the second diameter ‘D2’ of the second SCD cavity 206 is smaller than the third diameter ‘D3’ of the third SCD cavity 208. In an embodiment, the first diameter ‘D1’ is about 0.264 micrometer (μm), the second diameter ‘D2’ is about 0.5 μm, and the third diameter ‘D3’ is about 1.76 μm. The second diameter ‘D2’ and the third diameter ‘D3’ may be alternately referred to as the second SCD cavity diameter and the third SCD cavity diameter, respectively. The SCD cavities are further configured to fix sufficient leakage of energy of an evanescent field to the plasmonic layer that excites the surface plasmons with appropriate efficacy.

In some embodiments, the fiber core 202 includes six second SCD cavities 206. The six second SCD cavities are disposed around the first SCD cavity 204 in such a way that each of the six second SCD cavities 206 is located at an equal distance from the first SCD cavity 204. Further, the six second SCD cavities 206 forms a hexagonal shape around the first SCD cavity 204. As shown in FIG. 2A, two layers of the third SCD cavities 208 are disposed around the six second SCD cavities 206. A first layer disposed adjacent to the second SCD cavities 206 includes eleven third SCD cavities 208 and a second layer surrounds the first layer includes sixteen third SCD cavities 208. The number of second SCD cavities 206 and the third SCD cavities 208 disposed around the first SCD cavity 204 may vary based on various factors including, but not limited to, a cross-sectional area of the fiber core 202, and application of the PCF-SPR sensor 102. In some embodiments, the first SCD cavity 204, and each of the plurality of second SCD cavities 206 and the plurality of third SCD cavities 208 are separated by a pitch size ‘P’. The pitch size ‘P’ is defined as a distance between centers of the nearest neighboring first SCD cavity 204 and each of the nearest neighboring plurality of second and third SCD cavities 206, 208. In other words, each of the first SCD cavity 204, the second SCD cavities 206, and the third SCD cavities 208 are spaced from an adjacent SCD cavity by the pitch size ‘P’. More specifically, the first SCD cavity 204, the second SCD cavities 206, and the third SCD cavities 208 are equally spaced from each other by the pitch size ‘P’. In some embodiments, the pitch size ‘P’ is about 2.2 micrometer (μm).

The fiber core 202 further includes a groove 210 defined on an outer surface thereof. The groove 210 radially extends towards the central axis ‘A’ of the fiber core 202. Further, the groove 210 is defined between the first and the second layers of the third SCD cavities 208. In some embodiments, a surface 212 of the groove 210 is coated with a metal 214. According to an embodiment in the present disclosure, the metal 214 is gold and the fiber core 202 is a single-mode fused silica. In another embodiments, the fiber core 202 is a sapphire, a fused quartz, a synthetic quartz, a borosilicate, a soda lime glass, a fluoride glass, a phosphate glass, a chalcogenide glass, a plastic optical fiber, or any combination thereof. The fiber core 202 preferably consists of a single-mode fused silica except for the surface of the groove 210 which is coated with the metal 214. The metal 214 coated on the groove 210 has a first thickness ‘T1’. The metal coating on the surface 212 of the groove 210 may be alternately referred to as the gold layer. In some embodiments, the first thickness ‘T1’ of the metal is between 40 nm and 50 nm. In one embodiment of the present disclosure, the groove 210 is U-shaped. In some embodiments, a shape of the groove 210 may be a square, a rectangle, a semi-ellipse, a semi-circle, or any other shape known in the art. In some embodiments, the groove 210 has a width of about 2.0 μm and a depth of about 2.3 μm. The groove 210, the first SCD cavity 204, the plurality of second SCD cavities 206, and the plurality of third SCD cavities 208 extend axially along the fiber core 202. Further, the plurality of second SCD cavities 206 surrounds the first SCD cavity 204 and the plurality of third SCD cavities 208 surrounds the plurality of second SCD cavities 206 in such way to provide an evanescent field in an interface between the surface 212 of the groove 210 and the metal 214.

The PCF-SPR sensor 102 further includes an analyte channel 216 disposed around the fiber core 202 and configured to stream the analyte. The analyte channel 216 may be alternately referred to as the analyte layer. In particular, the analyte channel 216 surrounds the fiber core 202 and is in contact with the metal 214. The analyte channel 216 has a second thickness ‘T2’. In some embodiments, the second thickness ‘T2’ is about 1.36 μm. In an embodiment, peak magnitudes of the loss curves increase gradually with the enhancement of the second thickness ‘T2’ of the analyte channel 216. As a consequence, more light comes in contact with the metallic surface, causing the SPP modes to be energized. The PCF-SPR sensor 102 further includes an outer layer 218 surrounding the analyte channel 216 and having a third thickness ‘T3’. The outer layer 218, otherwise known as the perfectly matched layer (PML), is integrated with the analyte channel 216 to reduce outward radiation and to determine the structural geometry and material thickness of the PCF-SPR sensor 102. In some embodiments, the outer layer 218 is ZBLAN, Crown, BK7, Silica, or any combination thereof. Further, the outer layer 218 is designed in such a way that the waves incident upon the outer layer 218 from a non-PML medium do not reflect at the interface, therefore, the outer layer 218 strongly absorbs outgoing waves from an interior of a computational region without reflecting them back into the interior. In some embodiments, the PCF-SPR sensor 102 is fabricated by a stack and draw fiber drawing technique.

Referring to FIG. 2B, a schematic diagram of a stacked preform of the fiber core 202 is illustrated, according to an embodiment of the present disclosure. The hexagonal composition of the PCF-SPR sensor 102 is designed with three different circular types of the SCD cavities such as the first SCD cavity 204, the second SCD cavities 206, and the third SCD cavities 208. The SCD cavities help in creating the evanescent field, necessary to excite the electrons already present on the metal surface. In terms of fabrication, the distance, such as the pitch size ‘P’, between the two SCD cavities has the value of 2.2 μm. The third SCD cavities 208 are shown by thick wall capillary and has the third diameter ‘D3’ of 1.76 μm. The second SCD cavities 206 are represented by thin wall capillary and has the second diameter ‘D2’ of 0.5 μm. The first SCD cavity 204 is shown by thinner wall capillary with the first diameter ‘D1’ of 0.264 μm. The solid rod indicates that there is no cavity at that position. Further, the gold (Au) coating on the surface 212 of the groove 210 has the first thickness ‘T1’ of 45 nm, the liquid layer, such as the analyte channel 216, has the second thickness ‘T2’ of 1 μm and the perfectly matched layer (PML), such as the outer layer 218, has the third thickness ‘T3’ of 2.0 μm. By using the Sellmeier equation, evaluation of the refractive index of the fused silica can be done. (See: A. M. T. Hoque, A. Islam, F. Haider, H. A. B. A. Rashid, R. Ahmed, and R. A. Aoni, “Dual polarized surface plasmon resonance refractive index sensor via decentering propagation-controlled core sensor,” Opt. Continuum, vol. 1, no. 7, p. 1474 June 2022, doi: 10.1364/OPTCON. 460520, incorporated by reference hereby in its entirety.)

$${n}^{2} = 1 + {B}_{1} {λ}^{2} / ( {λ}^{2} - {C}_{1} ) + {B}_{2} {λ}^{2} / ( {λ}^{2} - {C}_{2} ) + {B}_{3} {λ}^{2} / ( {λ}^{2} - {C}_{3} ) \qquad ( 1 )$$

where λ is the wavelength in μm, n is the RI of the fused silica, Bᵢ=1, 2, 3 and Cᵢ=1, 2, 3 are Sellmeier constants. The availability of sufficient free electrons on the metal surface determines the affinity of analyte ligand binding when the energy transaction occurs. The electrical property of the plasmonic material directly modulates the sensitivity of the sensor 102.

The Drude-Lorenz model can be used to calculate the dielectric constant of Au (See: F. Haider, R. A. Aoni, R. Ahmed, M. S. Islam, and A. E. Miroshnichenko, “Propagation controlled photonic crystal fiber-based plasmonic sensor via scaled-down approach,” IEEE Sensors J., vol. 19, no. 3, pp. 962-969, February 2019, doi: 10.1109/JSEN.2018.2880161, incorporated by reference hereby in its entirety.),

$${ε}_{Au} = {ε}_{∞} - {ω}^{2} D / ω ( ω + j {λ}_{D} ) - {ΔωΩ}_{L}^{2} / ( ( {ω}^{2} - {Ω}_{L}^{2} ) + j {Γ}_{L} ω ) \qquad ( 2 )$$

where the permittivity of Au is denoted by ε_{Au} at a high frequency, ε_{∞} represents the permittivity at a constant value of 5.9673, and the angular frequency can be expressed as ω=2πc/λ where c indicates the velocity of light in free space. The plasmon frequency and damping wavelength are denoted by ω_{D} and λ_{D} whereas the magnitude of ω_{D}/2π and λ_{D}/2π are 2113.6 THz and 15.92 THz, respectively. As denotes the weighting factor, while Γ_{D}/2π represents the spectral width and Ω_{I}/2π stands for the oscillator strength, which have the magnitudes of 104.86 THz and 650.07 THz, respectively.

### EXAMPLES

The following details of the examples demonstrate the PCF-SPR sensor to detect the refractive index of the analyte as described herein. The examples are provided solely for illustration and are not to be construed as limitations of the present disclosure, as many variations thereof are possible without departing from the spirit and scope of the present disclosure.

### Example 1: Sensor Modelling

In FIG. 2A, the smallest cavity, such as the first SCD cavity 204, is located in the center to facilitate the phase matching of elementary core mode with SPP modes, while for instigating the birefringence effect, smaller SCD cavities, such as the second SCD cavities 206, are introduced that surrounds the first SCD cavity 204. In addition, the SCD cavities are introduced to fix the sufficient leakage of energy of the evanescent field to the plasmonic layer that excites the surface plasmons with appropriate efficacy. As shown in FIG. 1, the transverse magnetic or p-polarized electromagnetic wave is initially transmitted through the single-mode PCF by the light source 104. As a result, the electromagnetic wave gradually loses its intensity due to the dissipation of plasmonic energy at the interface. As such, the refractive index of the analyte is detected based on the intensity lost by the incident light passing through the PCF-SPR sensor 102 due to dissipation of the plasmonic energy. In other words, the refractive index of the analyte is detected based on the intensity difference between incident light entering the fiber core 202 and the incident light dissipated in the fiber core 202 as plasmonic energy.

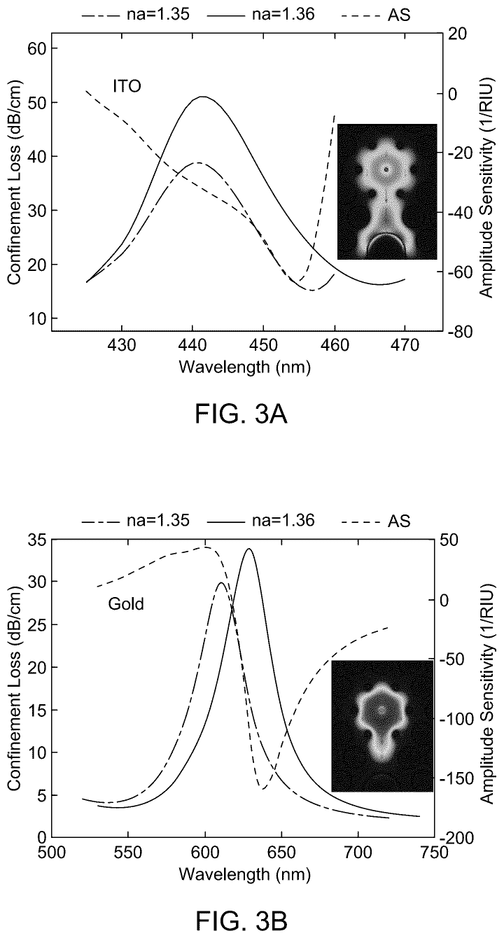

In FIGS. 3A-3B, the propagation loss and amplitude sensitivity (AS) curves, respectively, are depicted for different types of plasmonic materials. FIG. 3A is illustrated for indium-tin-oxide (ITO) metal that shows the peak confinement losses of 39 dB/cm and 51 dB/cm for RI of 1.35 and 1.36, respectively, and the wavelength sensitivity (WS) and AS for ITO are, respectively, 100 nm/RIU and 63 RIU⁻¹. FIG. 3B illustrates the peak confinement losses for Au of 30 dB/cm and 34 dB/cm for RI of 1.35 and 1.36, respectively. The WS and AS are 2000 nm/RIU and 159 RIU⁻¹, respectively, which are higher than ITO. The comparative data for the different plasmonic materials is shown in Table 1. It is quite evident that Au is quite appropriate as a plasmonic material in the PCF-SPR sensor 102, since it has comparatively better response.

TABLE 1
Precision data for plasmonic material selection

| Plasmonic | Resonant | Propagation loss | WS | AS |
|---|---|---|---|---|
| Material | wavelength (nm) | (dB/cm) | (nm/RIU) | (RIU⁻¹) |
| ITO | 441 (1.35) | 39 | 100 | 63 |
| | 442 (1.36) | 51 | | |
| Gold (Au) | 610 (1.35) | 30 | 2000 | 159 |
| | 630 (1.36) | 34 | | |

### Example 2: Surface Plasmon Polariton (SPP) Excitation

The working principle for the surface plasmon resonance (SPR) sensor depends on the interaction between the evanescent field and the metal overlay, where the propagating light beam penetrating in the cladding area results in evanescent field. The real portion of the effective RI of the core and the surface plasmon have equal value at the resonant point, while surface plasmon ripple is generated due to the excitation of the free electrons by the core-cladding evanescent field in the metal surface. Thus, a clearly marked loss is found at the resonant point and the unknown analyte RI can be identified by the variation of wavelength and amplitude. Furthermore, there are two fundamental modes due to the effect of birefringence.

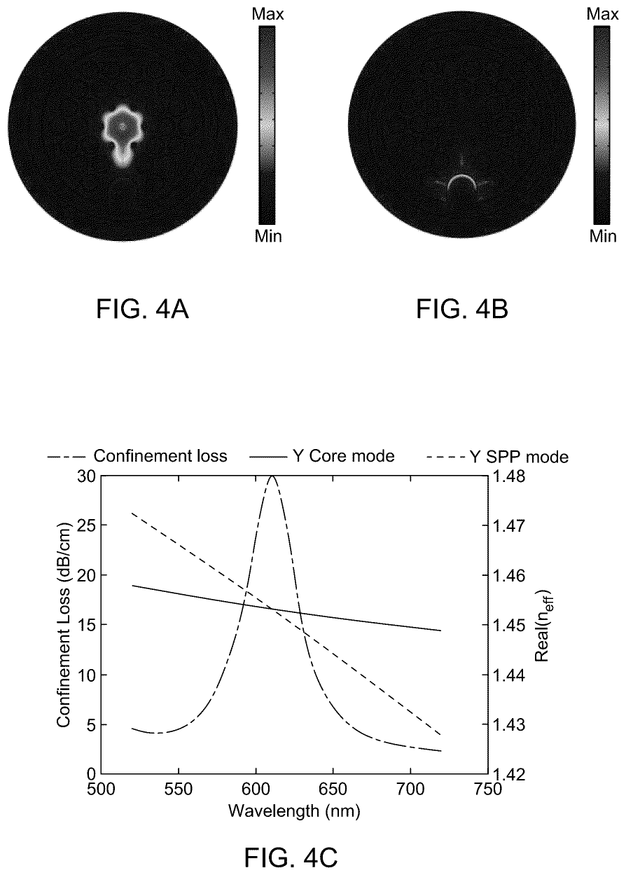

FIGS. 4A-4C illustrate the electric field distribution characteristics of the developed sensor's y-polarized mode as well as the cohesion between the core and SPP modes. In FIG. 4A and FIG. 4B, the core and SPP modes are shown for the analyte RI of 1.35, where the fractional fluctuation in the analyte RI affects the real refractive index parameters of the core and SPP modes. It is apparent that these two polarized modes have huge difference. FIG. 4C illustrates the phase matching phenomenon at a sample RI of 1.35, which is the dispersion connection between the core and SPP modes. The definitions of real (n_{eff}) for core guided and SPP modes for y-polarized mode are given in the legends of FIG. 4C. The core-guided mode and SPP mode's real (n_{eff}) are indicated by the solid and dotted lines, respectively. In addition, the coupled point for the index of core and SPP modes is found at 610 nm, and at this intersection point, maximum power is transferred from core to SPP modes (See: M. F. O. Hameed et al., “Design of highly sensitive multichannel bimetallic photonic crystal fiber biosensor”, J. Nanophotonics, vol. 10, no. 4, December 2016, Art. no. 046016). The phase matching technique can be justified by the coincidence of the coupled point and the peak loss that occurred at the resonant wavelength. However, we achieved an explicit model since the phase-matching requirement is almost precise at the resonant wavelength for RI of 1.35 for the y-polarized mode.

### Example 3: Model Analysis

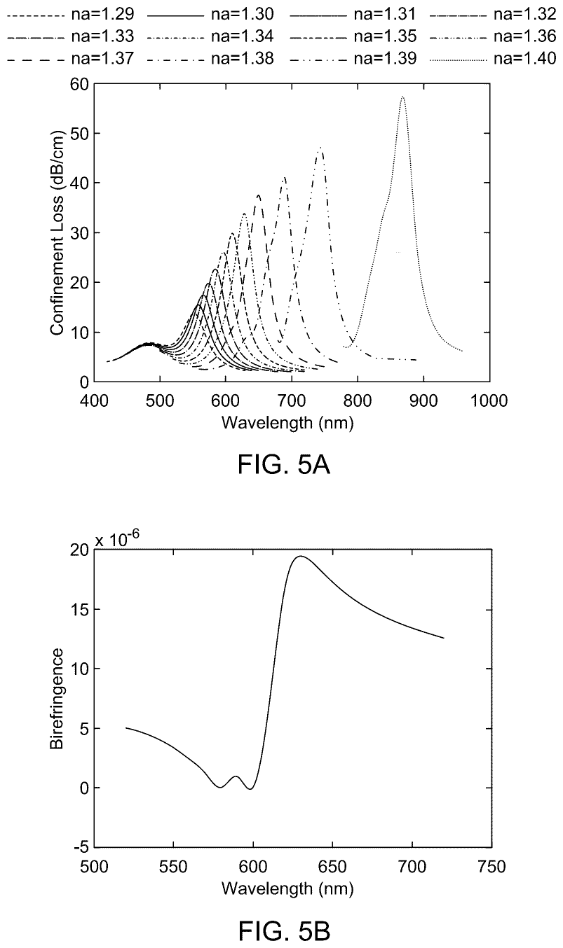

In order to evaluate the SPR properties, the confinement loss can be measured by the following equation.

$$α ( dB / cm ) = 8.686 \times {k}_{0} \times {I}_{m} ( {n}_{eff} ) \times {10}^{4} \qquad ( 3 )$$

where k₀=2π/λ indicates propagation constant in free space. The functional portion of the RI is symbolized by Iₘ(n_{eff}) and A indicates the operational wavelength. Due to slight discrepancy in RI value, the real portion of n_{eff} of the SPP mode varies, which results in varying the wavelength of phase matching. In addition, the phase matching wavelength variations display either red or blue shifting characteristics due to RI variations of the analyte (See: A. A. Rifat, F. Haider, R. Ahmed, G. A. Mahdiraji, F. R. M. Adikan, and A. E. Miroshnichenko, “Highly sensitive selectively coated photonic crystal fiber-based plasmonic sensor,” Opt. Lett., vol. 43, no. 4, pp. 891-894, 2018, doi: 10.1364/OL.43.000891). In FIG. 5A, the loss curves due to the variation of the analyte RI from 1.29 to 1.40 are presented. It shows the red shifting characteristics, since the resonant phase matching points are being shifted towards the higher wavelength with respect to the increment of the sample's RI. Thus, the shortest and longest resonant wavelengths are found for the sample RI of 1.29 and 1.40, respectively.

FIG. 5A also reveals the reduced energy shifting from core mode to its SPP mode. The resonant wavelength for the analyte RI of 1.29 appears at 553 nm for y-polarized mode and the corresponding loss spectrum is 13.6 dB/cm. The red shifting property and the index differences of core and SPP modes results in variation of the confinement loss. On the other hand, the resonant wavelength for the analyte RI of 1.40 appears at 870 nm and the corresponding loss spectrum is 57.6 dB/cm. However, the model of the present disclosure constitutes the highest WS of 12,500 nm/RIU. Usually, with the increase of sample refractive index, the contrast of RI of core and SPP modes causes the strong coupling, as a consequence, the PCF-SPR sensor 102 can be made more sensitive. Therefore, the PCF-SPR sensor 102 will exhibit an increased sensitivity with the analyte RI, which may lead to a nonlinear sensing response (See: F. Haider, M. Mashrafi, R. Haider, R. A. Aoni, R. Ahmed, and R. Ahmed, “Asymmetric core-guided polarization-dependent plasmonic biosensor,”). FIG. 5B illustrates the birefringence characteristics of the PCF-SPR sensor 102 for the sample RI of 1.38. The following equation can be used to calculate the sensor's birefringence feature (See: Design and Characterization of Highly Birefringent Residual Dispersion Compensating Photonic Crystal Fiber. Accessed: Jun. 14, 2022. (Online). Available: https://opg.optica.org/jlt/abstract.cfm?uri=jlt-32-23-3976)

$$B = \vert ( {n}_{x} - {n}_{y} ) \vert \qquad ( 4 )$$

where the refractive index of x and y polarized modes are denoted by nₓ and n_{y}, respectively. According to FIG. 5B, a significant variation between the two polarized modes is caused by birefringence, which grows gradually with the forward shifting of the operational wavelength. The large discrepancies indicate that the model of the present disclosure represents massive light coupling and forward movement of the peak wavelength in the x or y polarized modes, that generates more SPP on the dielectric interface of the metal (See: R. Otupiri, E. K. Akowuah, S. Haxha, H. Ademgil, F. AbdelMalek, and A. Aggoun, “A novel birefrigent photonic crystal fiber surface plasmon resonance biosensor,” IEEE Photon. J., vol. 6, no. 4, pp. 1-11, August 2014, doi: 10.1109/JPHOT.2014.2335716).

### Example 4: Sensitivity

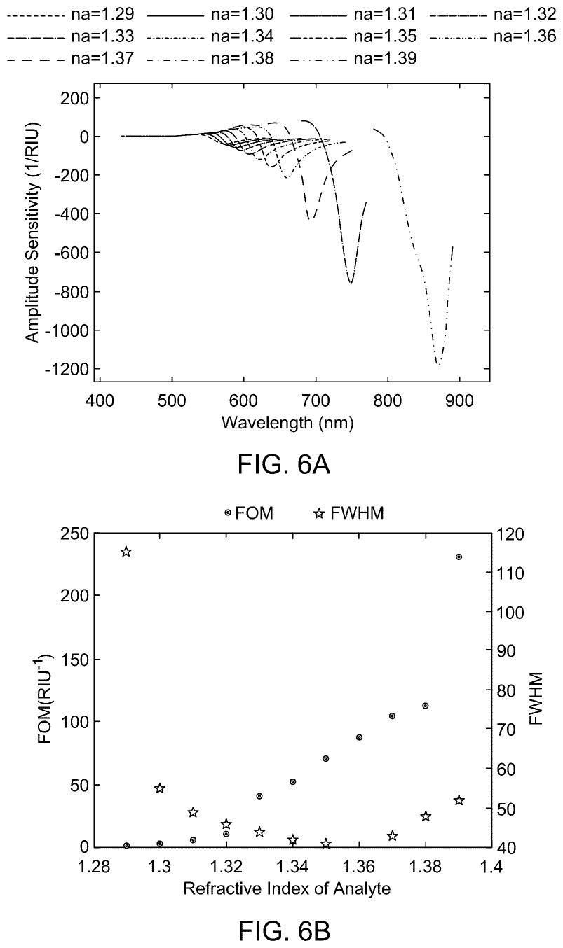

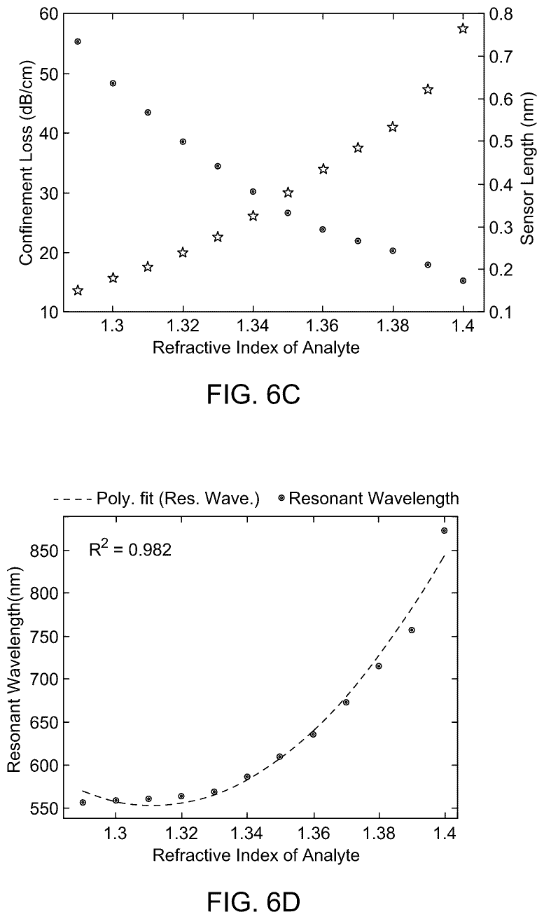

Using AS and WS techniques, the sensitivity of the PCF-SPR sensor 102 is calculated. When compared with the amplitude interrogation technique, the wavelength interrogation technique typically performs better in terms of sensitivity. The WS can be roughly calculated using the following equation (See: E. K. Akowuah, T. Gorman, H. Ademgil, S. Haxha, G. K. Robinson, and J. V. Oliver, “Numerical analysis of a photonic crystal fiber for biosensing applications,” IEEE J. Quantum Electron., vol. 48, no. 11, pp. 1403-1410 November 2012, doi: 10.1109/JQE.2012.2213803),

$${S}_{λ} ( λ ) = {Δλ}_{peak} / Δ {n}_{a} \qquad ( 5 )$$

where Δnₐ denotes the RI variation of analyte and Δλₚₑₐₖ denotes the shifting of resonant wavelength. Due to the increment of sample RI, the resonant wavelength red shifts and the index difference of core mode and SPP mode becomes smaller, and hence results in the variation of confinement loss (See: G. Wang, S. Li, G. An, X. Wang, Y. Zhao, W. Zhang, and H. Chen, “Highly sensitive D-shaped photonic crystal fiber biological sensors based on surface plasmon resonance,”). The PCF-SPR sensor 102 shows the highest WS and the sensing resolution of 12500 nm/RIU and 8.0×10⁻⁶ RIU (by considering the wavelength resolution of 0.1 nm) using the wavelength interrogation method (See: M. R. Hasan, S. Akter, A. A. Rifat, S. Rana, K. Ahmed, R. Ahmed, H. Subbaraman, and D. Abbott, “Spiral photonic crystal fiber-based dual-polarized surface plasmon resonance biosensor,” IEEE Sensors J., vol. 18, no. 1, pp. 133-140, January 2018). The resonant peak wavelengths are found at 553 nm, 559 nm, 567 nm, 576 nm, 585 nm, 597 nm, 610 nm, 630 nm, 651 nm, 690 nm, 745 nm, and 870 nm. The wavelength sensitivities of the PCF-SPR sensor 102 are 600 nm/RIU, 800 nm/RIU, 900 nm/RIU, 900 nm/RIU, 1200 nm/RIU, 1300 nm/RIU, 2000 nm/RIU, 2100 nm/RIU, 3900 nm/RIU, 5500 nm/RIU, and 12500 nm/RIU for the sample RI from 1.29 to 1.40, respectively. The variation of sample RI could affect the n_{eff} of SPP mode, core mode, and the penetration depth of the SPP field. For practical use, a calibration component is needed for each range of samples' refractive index. Another important sensing parameter for SPR based sensor is AS, which is more likely to be an affordable technique than wavelength interrogation (See: A. M. T. Hoque, A. Islam, F. Haider, H. A. B. A. Rashid, R. Ahmed, and R. A. Aoni, “Dual polarized surface plasmon resonance refractive index sensor via decentring propagation-controlled core sensor”, Opt. Continuum, vol. 1, no. 7, p. 1474 June 2022). Since the WS methodology uses the entire wave spectrum, this method and its applications are expensive. On the other hand, due to its ability to determine at a single wavelength, the amplitude interrogation approach is therefore regarded as the most cost-effective technique (See: F. Haider, M. Mashrafi, R. Haider, R. A. Aoni, R. Ahmed, and R. Ahmed, “Asymmetric core-guided polarization-dependent plasmonic biosensor,” Appl. Opt., vol. 59, no. 26, pp. 7829-7835 September 2020, doi: 10.1364/AO.400301, incorporated herein by reference in its entirety). The AS can be calculated by the following equation,

$${S}_{λ} ( {RIU}^{- 1} ) = - [ 1 / α ( λ {n}_{a} ) ] [ δ α ( λ {n}_{a} ) / δ {n}_{a} ] \qquad ( 6 )$$

where the loss depth is denoted by a (Ana) and is considered at any sample RI, and the distinction of the two corresponding loss spectra are denoted by δα(λnₐ). The AS of the PCF-SPR sensor 102, which was determined by changing the sample RI, is depicted in FIG. 6A. The AS values of the PCF-SPR sensor 102 are elevated in line with the increment of the sample RI by a specific difference of 0.01. The analyte with a RI of 1.39 was identified at 881 nm, and the maximum AS of the model is 1189 RIU⁻¹. Another significant parameter of the SPR sensor is the resolution of the PCF-SPR sensor 102, which means the detection capability during the detection of the smallest variation in analyte RI. The accuracy of a SPR sensor may be significantly less desirable as compared to its resolution. The resolution of the PCF-SPR sensor 102 can be determined by the following equation (See: A. A. Rifat, G. A. Mahdiraji, Y. M. Sua, Y. G. Shee, R. Ahmed, D. M. Chow, and F. R. M. Adikan, “Surface plasmon resonance photonic crystal fiber biosensor: A practical sensing approach,” IEEE Photon. Technol. Lett., vol. 27, no. 15, pp. 1628-1631 Aug. 1, 2015, doi: 10.1109/LPT.2015.2432812, incorporated by reference hereby in its entirety),

$$R ( RIU ) = Δ {n}_{a} \times ( Δ {λ}_{min} / Δ {λ}_{peak} ) \qquad ( 7 )$$

where the minimum spectrum resolution is pointed out by Δλₘᵢₙ while Δλₚₑₐₖ denotes the resonant wavelength peak shift. In the PCF-SPR sensor 102 of the present disclosure, the magnitudes of the several parameters are Δnₐ=0.01, Δλₘᵢₙ=0.1 nm, and Δλₚₑₐₖ=125 nm. By assuming the magnitude of minimum transmitted light intensity as 1% to be detected appropriately, a very high-resolution value of 8.0×10⁻⁶ RIU is obtained for the PCF-SPR sensor 102. Usually, the sensitivity performance of the PCF-SPR sensor 102 rely on the evanescent field, since a very intense evanescent field may cause the severe transmission loss in the fiber (See: N. Jahan, M. M. Rahman, M. Ahsan, M. A. Based, M. M. Rana, S. Gurusamy, and J. Haider, “Photonic crystal fiber based biosensor for pseudomonas bacteria detection: A simulation study,”, incorporated by reference hereby in its entirety).

### Example 5: Figure of Merit (FOM) and Polynomial Fitting

Several significant parameters such as FOM and signal-to-noise ratio (SNR) are also responsible for describing the quality of the PCF-SPR sensor 102. These parameters are related to the full width at half maximum (FWHM) also represented as (Δλ_{1/2}) and can be expressed as (See: M. S. A. Gandhi, K. Senthilnathan, P. R. Babu, and Q. Li, “Visible to near infrared highly sensitive microbiosensor based on surface plasmon polariton with external sensing approach,” Results Phys., vol. 15, December 2019, Art. no. 102590, doi: 10.1016/J.RINP.2019.102590, incorporated by reference hereby in its entirety),

$$FOM = {S}_{λ} / {Δλ}_{1 / 2} , \qquad ( 8 )$$

$$SNR = {Δλ}_{peak} / {Δλ}_{1 / 2} \qquad ( 9 )$$

The maximum FOM and FWHM values of the PCF-SPR sensor 102 are 240.39 RIU⁻¹ and 115 nm, respectively. In FIG. 6B, the values of FOM and FWHM with respect to the change in RI of the sample are presented. According to FIG. 6B, the values of FWHM steadily decrease as analyte RI increases. Additionally, because the FOM is the ratio of WS to FWHM, it exhibits inverse characteristics. Additionally, the FOM also implies the output proficiency of the sensors. However, the maximum values of FOM and FWHM were observed at analyte RIs of 1.40 and 1.29, respectively, and FOM should be as high as possible for an SPR sensor with high sensitivity. Equation 9 provides the maximum and minimum values of SNR are 0.052 and 2.404, respectively.

The relationship between the length and loss depth of the PCF-SPR sensor 102 is depicted in FIG. 6C, where the length of the PCF-SPR sensor 102 is inversely proportional to confinement loss and vice versa. The model precisely reveals the detection sensitivity of an unknown liquid's RI, which is restricted to a few centimetres to millimetres. The length of the PCF-SPR sensor 102 may be constrained by the extreme confinement loss, if the loss depth is too large, and incident light may provide an undetected signal in the system output. Once the incidence light is set, it may also all of a sudden become invisible. The loss depth of the PCF-SPR sensor 102 also reveals the coupling strength. If it is too low, the performance of the PCF-SPR sensor 102 will also degrade. Additionally, the PCF-SPR sensor 102 offers superior sensitivity performance with regards to the forward fluctuation of the sample RI (See: V. Kaur and S. Singh, “Design of titanium nitride coated PCF-SPR sensor for liquid sensing applications,” Opt. Fiber Technol., vol. 48, pp. 159-164, March 2019, doi: 10.1016/j.yofte.2018.12.015; J. Wang, L. Pei, L. Wu, J. Wang, Z. Ruan, and J. Zheng, “A polarizationindependent SPR sensor based on photonic crystal fiber for low RI detection,” Plasmonics, vol. 15, no. 2, pp. 327-333, October 2019, doi: 10.1007/S11468-019-01054-0; and C. Liu, J. Wang, F. Wang, W. Su, L. Yang, J. Lv, G. Fu, X. Li, Q. Liu, T. Sun, and P. K. Chu, “Surface plasmon resonance (SPR) infrared sensor based on D-shape photonic crystal fibers with ITO coatings,” Opt. Commun., vol. 464, June 2020, Art. no. 125496, incorporated by reference hereby in its entirety) due to the strong light coupling strength. As a result, the PCF-SPR sensor 102 may achieve the lowest possible confinement loss. Because the analyte RI moves forward in the PCF-SPR sensor 102, the propagation loss and resonant point shifts forward (See: C. Li et al., “Two modes excited SPR sensor employing gold-coated photonic crystal fiber based on three-layers air-holes”, IEEE Sensors J., vol. 20, no. 11, pp. 5893-5899 June 2020, incorporated by reference hereby in its entirety). For the RIs of 1.29 and 1.40, respectively, the sensor length is 0.74 mm and 0.17 mm at its highest and lowest values.

The second order polynomial curve fitting of the model is depicted in FIG. 6D. The R2 value of 0.982 was obtained, which means that this is a highly responsive sensor and achieves high accuracy. Table 2 provides a detailed illustration of the characteristics of the PCF-SPR sensor 102.

TABLE 2
The performance of the present invention for y polarized mode

| | Res. | Peak | Res. | Wave. | Ampl. | | | | Wave. | |
|---|---|---|---|---|---|---|---|---|---|---|
| Analyte | Wave. | loss | Shift | Sens. | Sens. | FWHM | FOM | | Res. | DL |
| RI | (nm) | (dB/cm) | (nm) | (nm/RIU) | (RIU⁻¹) | (nm) | (RIU⁻¹) | SNR | (RIU) | (RIU²/nm) |
| 1.29 | 553 | 13.6 | 6 | 600 | 32 | 115 | 5.22 | 0.052 | 1.67*10⁻⁴ | 1.33*10⁻⁸ |
| 1.30 | 559 | 15.7 | 8 | 800 | 41 | 55 | 14.55 | 0.145 | 1.25*10⁻⁴ | 1.00*10⁻⁸ |
| 1.31 | 567 | 17.6 | 9 | 900 | 58 | 49 | 18.37 | 0.184 | 1.11*10⁻⁴ | 8.89*10⁻⁸ |
| 1.32 | 576 | 20 | 9 | 900 | 73 | 46 | 19.57 | 0.196 | 1.11*10⁻⁴ | 8.89*10⁻⁸ |
| 1.33 | 585 | 22.6 | 12 | 1200 | 92 | 44 | 27.27 | 0.273 | 8.33*10⁻⁴ | 6.67*10⁻⁸ |
| 1.34 | 597 | 26.1 | 13 | 1300 | 120 | 42 | 30.95 | 0.31 | 7.69*10⁻⁴ | 6.15*10⁻⁸ |
| 1.35 | 610 | 30 | 20 | 2000 | 159 | 41 | 48.78 | 0.488 | 5.00*10⁻⁴ | 4.00*10⁻⁸ |
| 1.36 | 630 | 34 | 21 | 2100 | 214 | 40 | 52.50 | 0.525 | 4.76*10⁻⁴ | 3.81*10⁻⁸ |
| 1.37 | 651 | 37.5 | 39 | 3900 | 440 | 43 | 90.70 | 0.907 | 2.56*10⁻⁴ | 2.05*10⁻⁸ |
| 1.38 | 690 | 41 | 55 | 5500 | 756 | 48 | 11.58 | 1.146 | 1.82*10⁻⁴ | 1.45*10⁻⁸ |
| 1.39 | 745 | 47.3 | 125 | 12500 | 1189 | 52 | 240.39 | 2.404 | 8.00*10⁻⁴ | 6.4*10⁻⁸ |
| 1.40 | 870 | 57.5 | N/A | N/A | N/A | 59 | N/A | N/A | N/A | N/A |

### Example 6: Fiber Core Arrangement

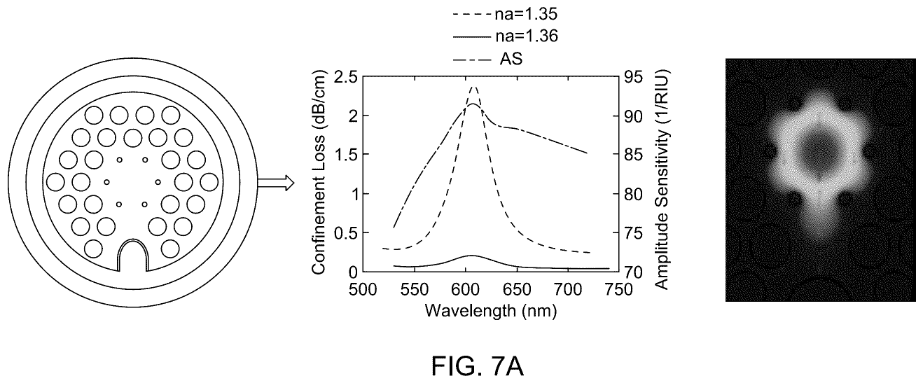

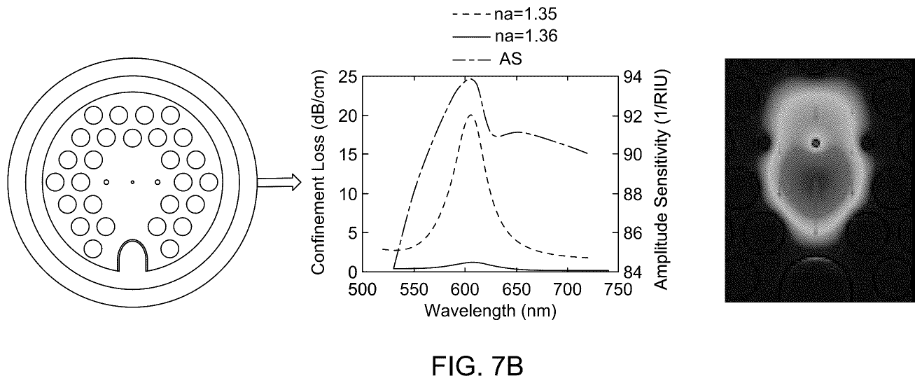

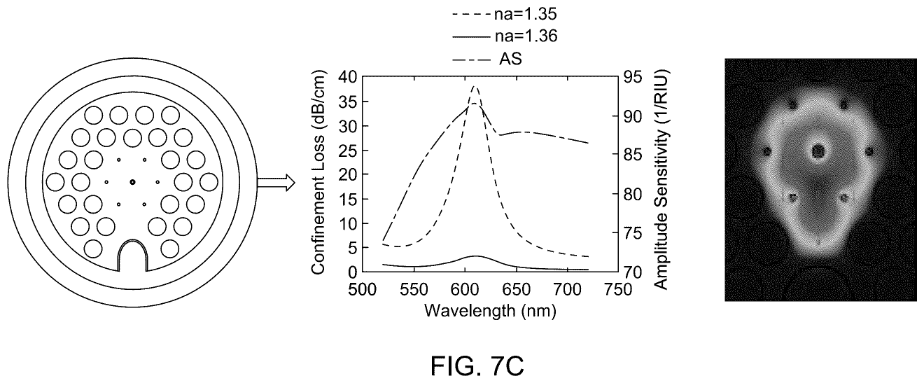

For the stimulation of the sensing channels and the transmission of light, the fiber core 202 plays a vital role. The effect of SCD cavities arrangement on light propagation for the sample RIs of 1.35 and 1.36 was studied, as shown in FIGS. 7A-7C. Firstly, by eliminating the central cavity, as depicted in FIG. 7A, the externally existing sensing channel exhibits extremely low confinement losses of 2.4 dB/cm for the sample RI of 1.35 and 0.2 dB/cm for the sample RI of 1.36 at 608 nm and 609 nm, respectively. Additionally, compared to the model of the present disclosure, the wavelength and AS for the solid core are very low at 100 nm/RIU and 91 RIU⁻¹, respectively. Secondly, the effect of the second SCD cavities arrangement was studied by leaving the first SCD cavity 204 in place and removing the four second SCD cavities 206 from the central cavity's upper and lower sides as depicted in FIG. 7B.

The model depicts loss depth of 21 dB/cm and 1.3 dB/cm at 606 nm and 609 nm for RI of 1.35 and 1.36, respectively, with strong coupling intensity. However, the wavelength and AS for omitted SCD cavities investigation has moderate values of 300 nm/RIU and 94 RIU⁻¹, respectively. Finally, the first SCD cavity 204 and the second SCD cavities 206 are replaced in the reverse position as depicted in FIG. 7C. The model shows high confinement loss as compared to FIG. 7A and FIG. 7B, which is around 38 dB/cm and 3.2 dB/cm at 610 nm and 613 nm for RIs of 1.35 and 1.36, respectively. Since the sensing signal in the output system dissipates instantly after launching the incident light, the significant confinement loss restricts the fiber length and makes it impossible to measure in practice. The wavelength and AS for reversing SCD cavities investigation has almost similar values as compared to omitted investigation, of 300 nm/RIU and 92 RIU⁻¹, respectively. However, the SCD cavities are taken into consideration when creating the light-transmitting core. This shows that the cavity distribution performs the best when compared to the other designs as illustrated in Table 3 in order to obtain a high sensitivity response from the design of the fiber core 202.

TABLE 3
Fiber core investigation

| | WS | AS |
|---|---|---|
| Fiber core Investigation | (nm/RIU) | (RIU⁻¹) |
| Solid core | 100 | 91 |
| Omitted core | 300 | 94 |
| Reversing core | 300 | 92 |
| Core of the present | 2000 | 159 |
| disclosure | | |

### Example 7: Metal Thickness

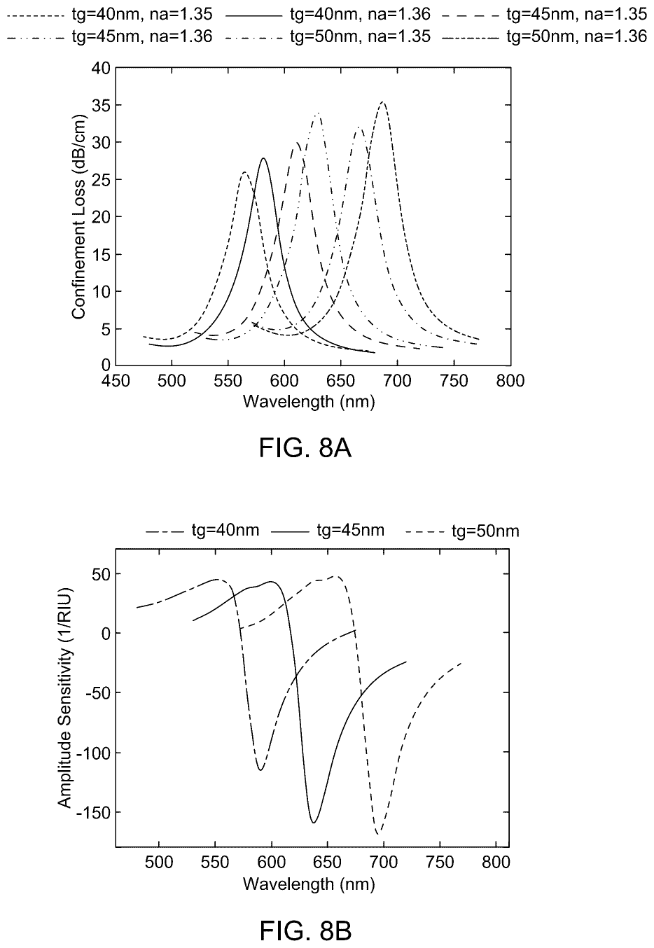

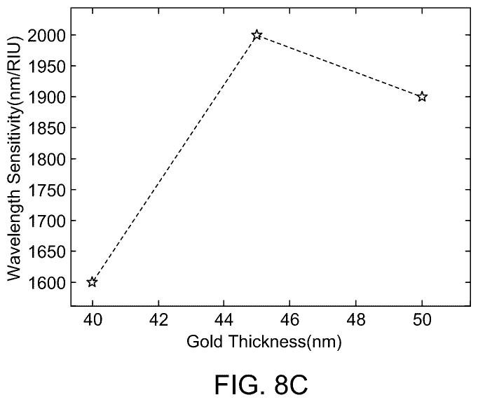

The depth of the Au coating affects the detecting abilities. FIG. 8A illustrates the red shifting characteristics of the loss spectrum of the PCF-SPR sensor 102 with increase in Au layer thickness and demonstrates that the change in sensing performance is a result of the first thickness ‘T1’ of the metal coating. Peak losses of 32 dB/cm and 35 dB/cm were discovered for the sample RI of 1.35 and 1.36, respectively, at 667 nm and 686 nm, which are 6.67% and 3% higher than the values discovered for the first thickness ‘T1’ of 45 nm. Similarly, for the same RI, the minimum losses of 26 dB/cm and 28 dB/cm were found at T1=40 nm, that occurred at 565 nm and 581 nm, respectively, which are 13.3% and 6.67% less than the first thickness of 45 nm. In the case of Au, the phase matching wavelength is redshifted as a result of an increase in layer depth, which raises the effective refractive index (n_{eff}) of the SPP mode. Additionally, as the Au layer gets thicker, the loss-depth likewise gets increasingly deeper. Similar results were seen for the AS, as shown in FIG. 8B, where the AS gradually grows as a result of the expansion of the Au layer. Additionally, a higher Au metal damping loss may result from the thicker Au layer. The maximum AS is discovered for the Au thickness of 50 nm and is 166 RIU⁻¹ at 696 nm resonant wavelength, which is 4.5% higher than the ideal value of 159 RIU⁻¹. When the Au thickness is 40 nm, the AS steadily declines to 114 RIU⁻¹, which is −28.3% of the first thickness of 45 nm as can be seen from FIG. 8C.

### Example 8: Pitch Value

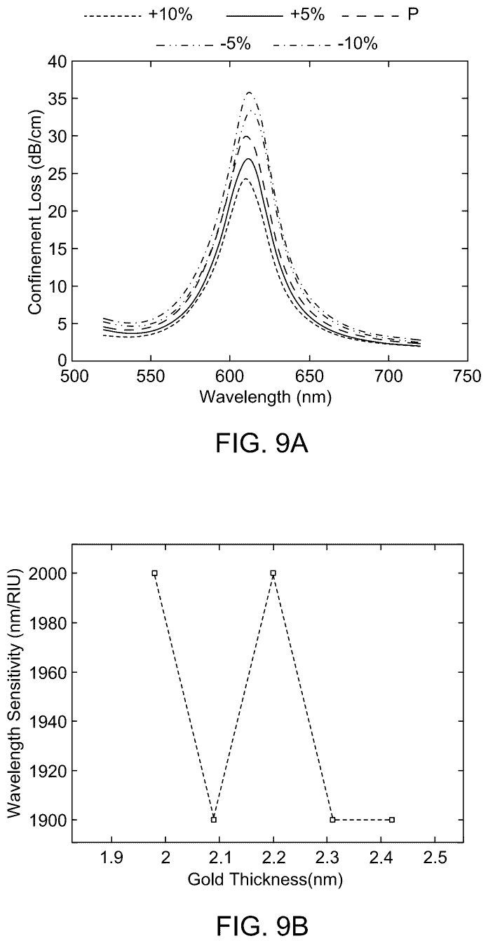

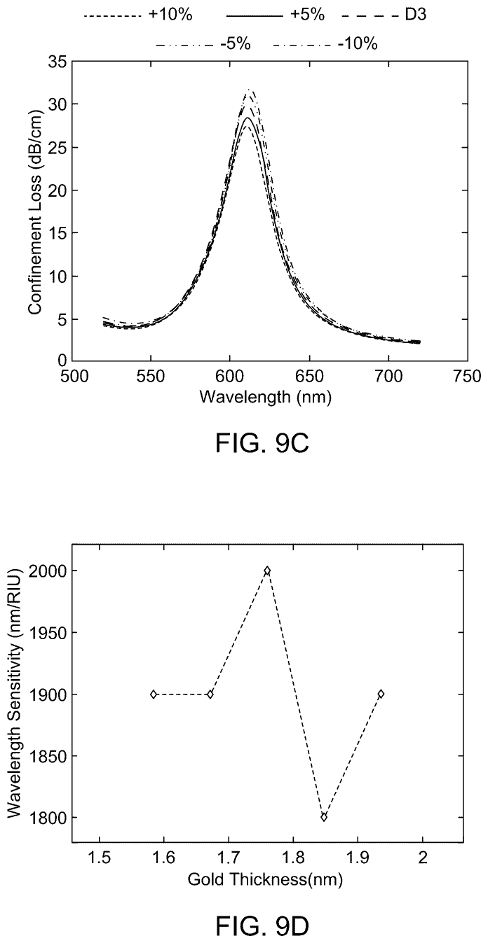

Additionally, manufacturing tolerances is included in the performance study to improve the efficiency of the PCF-SPR sensor 102. FIG. 9A illustrates the variation in confinement loss as a result of structural modification in the pitch size ‘P’. When the pitch size ‘P’ is altered by 10% from the value of 2.2 μm, the sensor 102 shows reduced variation influence on loss depth. Confinement losses at positive 10% and positive 5% of the pitch size of 2.2 μm are, 16.7% and 10%, respectively, and 25 dB/cm and 27 dB/cm below optimal values, respectively, at 610 nm and 611 nm. For 5% and 10% decrement of the pitch size ‘P’, the losses found are 34 dB/cm and 36 dB/cm at 613 nm and 612 nm, respectively, which are successively 13.3% and 20% higher than the pitch size of 2.2 μm.

Besides, the loss spectrum seems to steadily diminish as the pitch size ‘P’ increases, and vice versa. In addition, when the wavelength is reduced, the peak wavelength red shifts and vice versa. FIG. 9B illustrates the small effect in wavelength interrogation due to pitch size variation from negative 10% to positive 10%. The wavelength sensitivities of 2000 nm/RIU, 1900 nm/RIU, 2000 nm/RIU, 1900 nm/RIU, and 1900 nm/RIU for successive variations were obtained.

### Example 9: Cavities Diameter

The effect of shifting configurational parameter values, which may or may not be severe in the case of cavity diameter, can be predicted from pitch value alternation. The spectrum depth for a third SCD cavity diameter variation of 10% is depicted in FIG. 9C, where the change of the loss depths is negligible. Loss depths of 28.4 dB/cm and 29.4 dB/cm at 611 nm and 609 nm, respectively, were obtained. The loss depth values are decreased by 5% and 2% with 5% and 10% increment to the third diameter of 1.76 μm. Additionally, loss depths of 31 dB/cm and 32 dB/cm at 611 and 612 nm were obtained respectively, for 5% and 10% decrement, which are 5% and 2% increase, respectively. The loss depths increase slightly as the size of the third SCD air-hole decreases. This increased light confinement spreads with the aid of an asymmetric core guided formation. As a result, more light can interact with the metal layer, stimulating SPP modes. As a result, no significant resonance wavelength shifting happens as the width of the cavity changes. FIG. 9D illustrates how the third diameter ‘D3’ value fluctuation from negative 10% to positive 10% has less of an impact on wavelength interrogation. For sequential variation, the wavelength sensitivities of 1900 nm/RIU, 1900 nm/RIU, 2000 nm/RIU, 1800 nm/RIU, and 1900 nm/RIU were obtained, respectively.

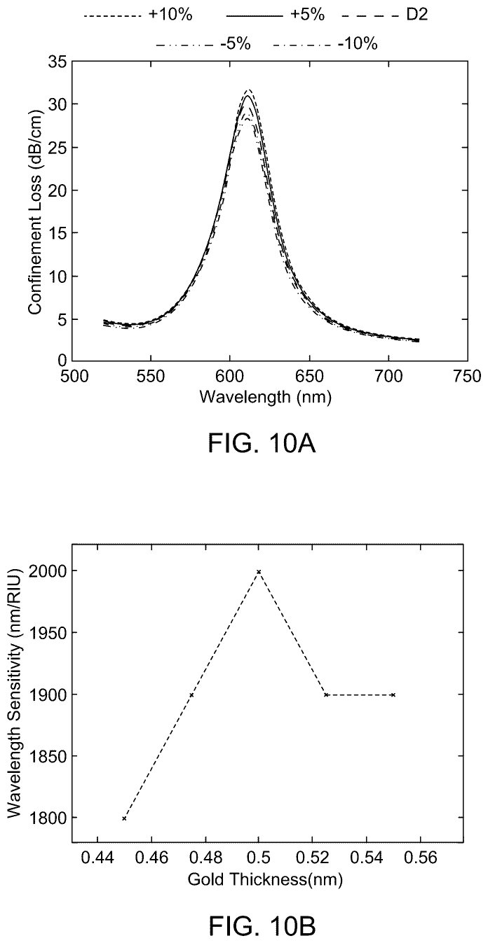

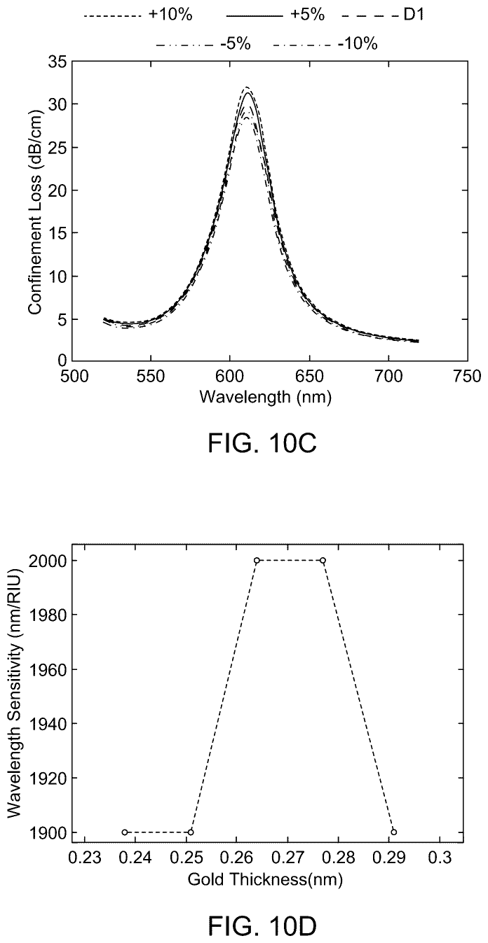

FIG. 10A illustrates the performance of the PCF-SPR sensor 102 or loss spectrum impact as a function of second SCD cavity dimensions modification (second SCD cavities that are taken into consideration along the asymmetric-core formation). Even when the diameter (D2=0.5 μm) is increased or lowered by +10%, the spectrum depth is nearly unchanged. As the size of the second SCD air-hole is reduced, the depth of the loss grows progressively. For positive 10%, positive 5%, negative 5%, and negative 10% variations, the loss depths are 32 dB/cm, 31 dB/cm, 29 dB/cm, and 28 dB/cm at 612 nm, 611 nm, 610.5 nm, and 610 nm, respectively. The successive loss depths are positive 6.67%, positive 3.3%, negative 3.3% and negative 6.67% higher or lower than the value of 30 dB/cm at 610 nm. As a result, there are no major changes in loss depths, and resonance frequency shifting takes place as the width of the cavities change. FIG. 10B illustrates the effect on wavelength interrogation due to the D2 value variations that causes the D1 value variation from negative 10% to positive 10%.

FIG. 10C illustrates the performance of the PCF-SPR sensor 102 or the loss spectrum impact as a function of the narrower SCD cavity diameter. There are very small spectrum intervals among curves even though the diameter (D1=0.264 μm) is increased or decreased by +10%. Loss depth rises gradually according to the increment of SCD air-hole size. For positive 10%, positive 5%, negative 5%, and negative 10% variations, the loss depths are 32 dB/cm, 31.3 dB/cm, 29.2 dB/cm, and 28.4 dB/cm at 612 nm, 611 nm, 610.5 nm, and 610 nm, respectively. The successive loss depths are positive 6.6%, positive 4.3%, negative 2.6% and negative 5.3% higher or lower than the value of 30 dB/cm. Overall, there is almost no significant loss depth variations and resonant wavelength shifting due to the diameter variations in the cavities. FIG. 10D illustrates the wavelength variation due to the D1 value variation from negative 10% to positive 10%.

### Example 10: Analyte Layer

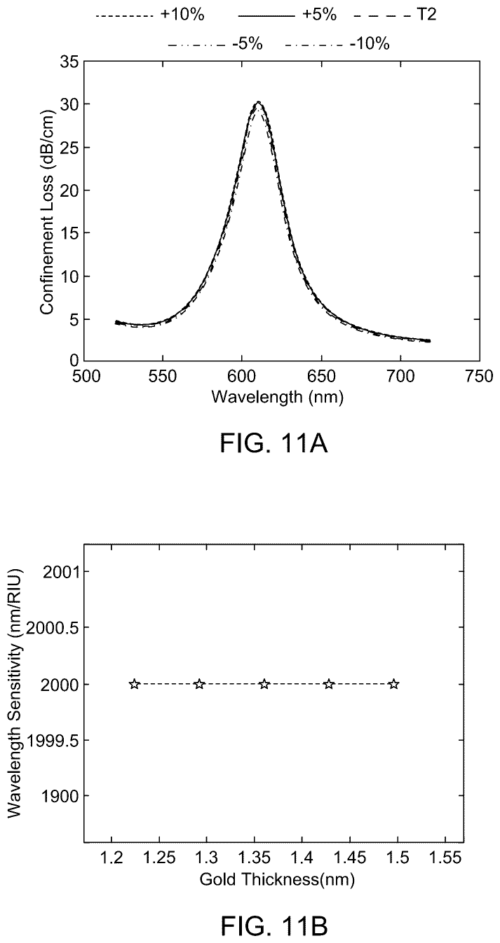

FIG. 11A illustrates that there are nearly no spectrum depth differences for the analyte layer thickness variations by ±5% to ±10% from 1.36 μm. In this case, peak magnitudes of loss curves increase gradually with the enhancement of sample layer depth. As a consequence, more light comes in contact with the metallic surface, causing the SPP modes to be energized. For ±10% variations, resonant wavelengths for those corresponding variations almost remain comparable. Here 611 nm is the resonant wavelength for the second thickness ‘T2’. In contrast, with the decrement of negative 10% and negative 5%, the peak loss magnitudes are at 29.26 and 29.63 dB/cm, respectively, which led to 5% and 4% decrease, respectively, and both resonant peaks appear at 610 nm. Similarly, for the positive 10% and positive 5% changes, the peak loss values are 30.26 and 30.07 dB/cm, which is increased by 2.2% and 2.7%, and both resonant peaks appear at 610 nm. Therefore, no significant propagation loss and resonance wavelength shifting occur with diameter variations of the cavities. FIG. 11B depicts the effect in wavelength variation due to the variation in the first thickness ‘T1’. A WS of 2000 nm/RIU is obtained for all corresponding variations that is approximately the same with the WS at the first thickness ‘T1’.

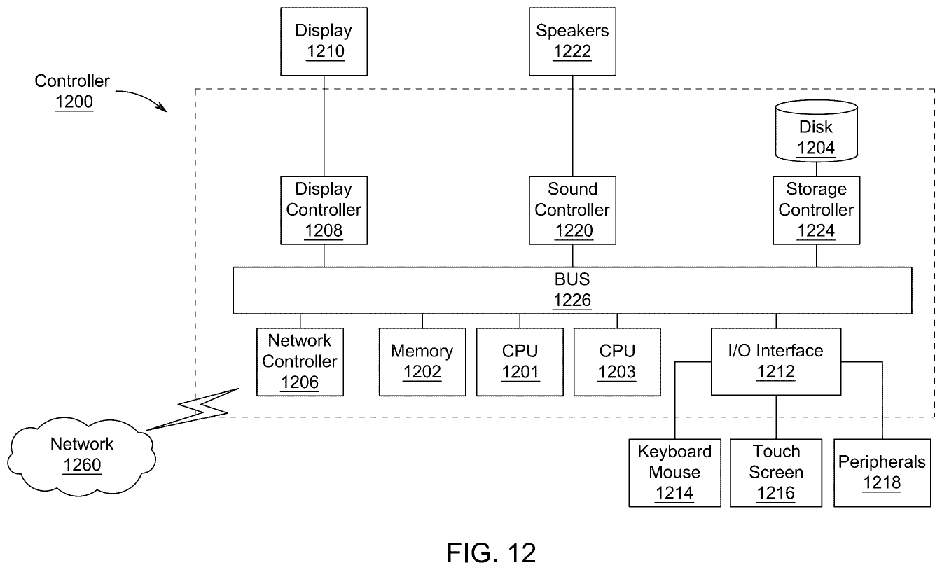

Details of hardware description of the computing environment according to exemplary embodiments is described with reference to FIG. 12. In FIG. 12, a controller 1200 is described which is representative of the computer 108 of FIG. 1 in which the controller 110 is a computing device which includes a CPU 1201 which performs the processes described above/below. The process data and instructions may be stored in memory 1202. These processes and instructions may also be stored on a storage medium disk 1204 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1201, 1203 and an operating system such as Microsoft Windows 7, Microsoft Windows 10, Microsoft Windows 11, UNIX, Solaris, LINUX, Apple MAC-OS, and other systems known to those skilled in the art.

The hardware elements in order to achieve the computing device may be realized by various circuitry elements, known to those skilled in the art. For example, CPU 1201 or CPU 1203 may be a Xenon or Core processor from Intel of America or an Opteron processor from AMD of America, or may be other processor types that would be recognized by one of ordinary skill in the art. Alternatively, the CPU 1201, 1203 may be implemented on an FPGA, ASIC, PLD or using discrete logic circuits, as one of ordinary skill in the art would recognize. Further, CPU 1201, 1203 may be implemented as multiple processors cooperatively working in parallel to perform the instructions of the inventive processes described above.

The computing device in FIG. 12 also includes a network controller 1206, such as an Intel Ethernet PRO network interface card from Intel Corporation of America, for interfacing with network 1260. As can be appreciated, the network 1260 can be a public network, such as the Internet, or a private network such as an LAN or WAN network, or any combination thereof and can also include PSTN or ISDN sub-networks. The network 1260 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1208, such as a NVIDIA Geforce GTX or Quadro graphics adaptor from NVIDIA Corporation of America for interfacing with display 1210, such as a Hewlett Packard HPL2445w LCD monitor. A general purpose I/O interface 1212 interfaces with a keyboard and/or mouse 1214 as well as a touch screen panel 1216 on or separate from display 1210. General purpose I/O interface also connects to a variety of peripherals 1218 including printers and scanners, such as an OfficeJet or DeskJet from Hewlett Packard.

A sound controller 1220 is also provided in the computing device such as Sound Blaster X-Fi Titanium from Creative, to interface with speakers/microphone 1222 thereby providing sounds and/or music.

The general purpose storage controller 1224 connects the storage medium disk 1204 with communication bus 1226, which may be an ISA, EISA, VESA, PCI, or similar, for interconnecting all of the components of the computing device. A description of the general features and functionality of the display 1210, keyboard and/or mouse 1214, as well as the display controller 1208, storage controller 1224, network controller 1206, sound controller 1220, and general purpose I/O interface 1212 is omitted herein for brevity as these features are known.

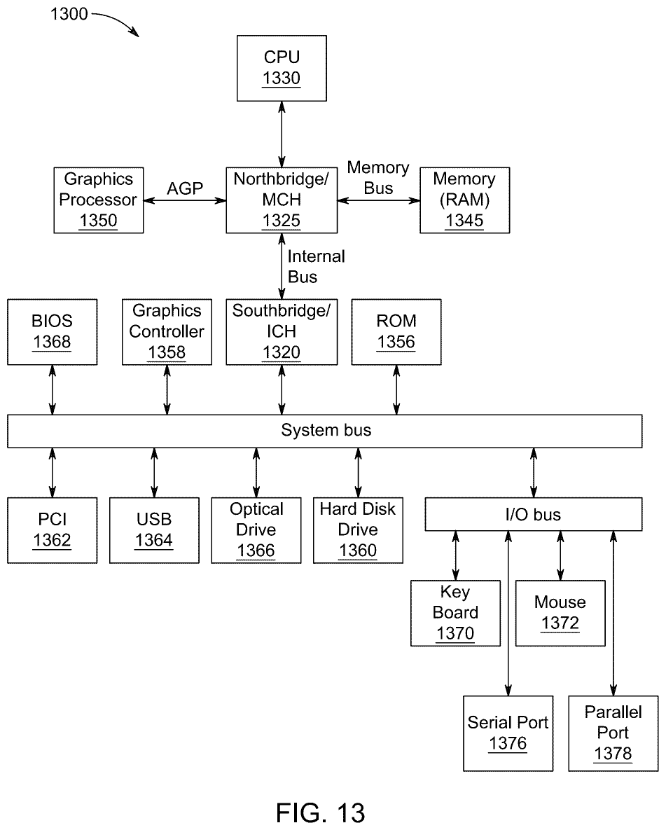

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 13.

FIG. 13 shows a schematic diagram of a data processing system, according to certain embodiments, for performing the functions of the exemplary embodiments. The data processing system is an example of a computer in which code or instructions implementing the processes of the illustrative embodiments may be located.

In FIG. 13, data processing system 1300 employs a hub architecture including a north bridge and memory controller hub (NB/MCH) 1325 and a south bridge and input/output (I/O) controller hub (SB/ICH) 1320. The central processing unit (CPU) 1330 is connected to NB/MCH 1325. The NB/MCH 1325 also connects to the memory 1345 via a memory bus, and connects to the graphics processor 1350 via an accelerated graphics port (AGP). The NB/MCH 1325 also connects to the SB/ICH 1320 via an internal bus (e.g., a unified media interface or a direct media interface). The CPU Processing unit 1330 may contain one or more processors and even may be implemented using one or more heterogeneous processor systems.

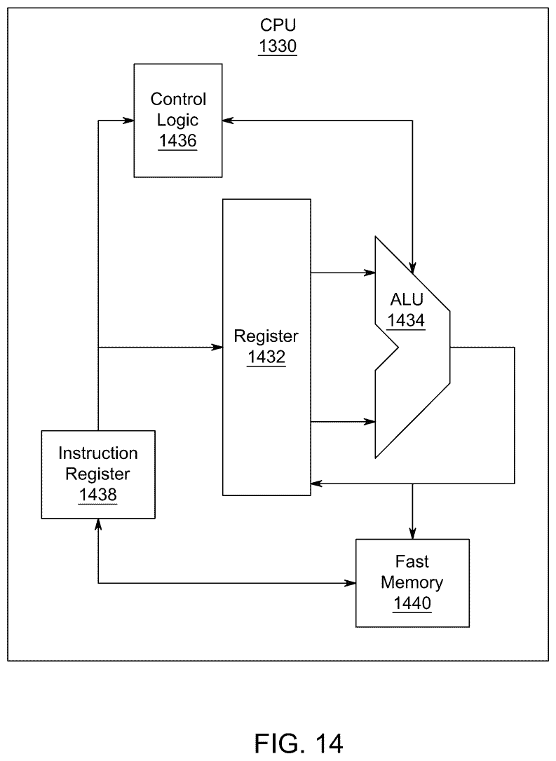

For example, FIG. 14 shows one implementation of CPU 1330. In one implementation, the instruction register 1438 retrieves instructions from the fast memory 1440. At least part of these instructions are fetched from the instruction register 1438 by the control logic 1436 and interpreted according to the instruction set architecture of the CPU 1330. Part of the instructions can also be directed to the register 1432. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1434 that loads values from the register 1432 and performs logical and mathematical operations on the loaded values according to the instructions. The results from these operations can be feedback into the register and/or stored in the fast memory 1440. According to certain implementations, the instruction set architecture of the CPU 1330 can use a reduced instruction set architecture, a complex instruction set architecture, a vector processor architecture, a very large instruction word architecture. Furthermore, the CPU 1330 can be based on the Von Neuman model or the Harvard model. The CPU 1330 can be a digital signal processor, an FPGA, an ASIC, a PLA, a PLD, or a CPLD. Further, the CPU 1330 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 13, the data processing system 1300 can include that the SB/ICH 1320 is coupled through a system bus to an I/O Bus, a read only memory (ROM) 1356, universal serial bus (USB) port 1364, a flash binary input/output system (BIOS) 1368, and a graphics controller 1358. PCI/PCIe devices can also be coupled to SB/ICH 1388 through a PCI bus 1362.

The PCI devices may include, for example, Ethernet adapters, add-in cards, and PC cards for notebook computers. The Hard disk drive 1360 and CD-ROM 1366 can use, for example, an integrated drive electronics (IDE) or serial advanced technology attachment (SATA) interface. In one implementation the I/O bus can include a super I/O (SIO) device.

Further, the hard disk drive (HDD) 1360 and optical drive 1366 can also be coupled to the SB/ICH 1320 through a system bus. In one implementation, a keyboard 1370, a mouse 1372, a parallel port 1378, and a serial port 1376 can be connected to the system bus through the I/O bus. Other peripherals and devices that can be connected to the SB/ICH 1320 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

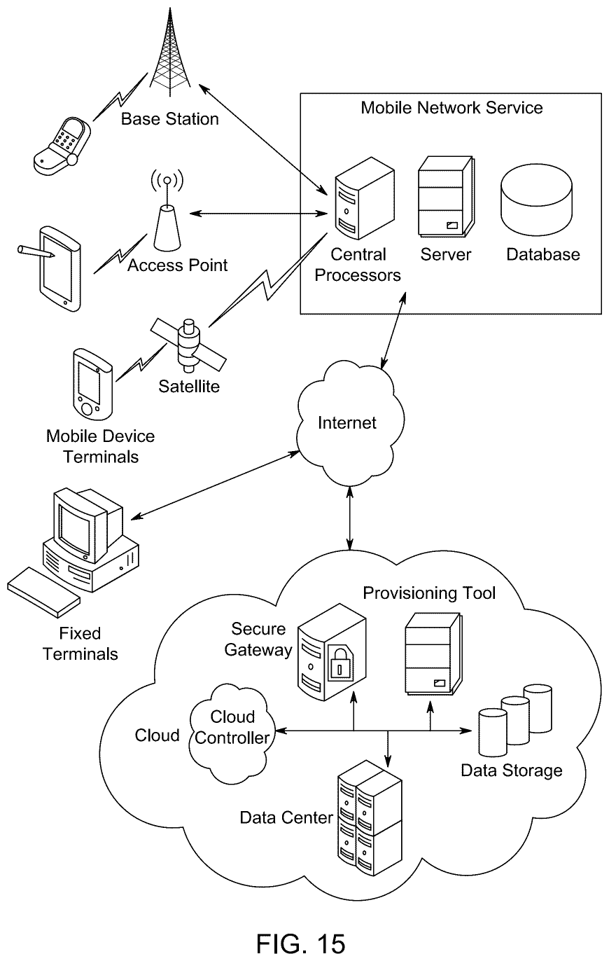

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 15, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

According to the present disclosure, the symmetric and hexagonal core PCF-SPR sensor 102 is disclosed in order to determine how plasmonic sensing is controlled by propagation. To attain maximum sensitivity, the measurable forming factors of the model are numerically examined using finite element method (FEM). The PCF-SPR sensor 102 exhibits an extreme sensitivity of 1189 RIU⁻¹ for the amplitude interrogation technique, while having a remarkable sensitivity and resolution of 12,500 nm/RIU and 8.0×10⁻⁶ RIU, respectively. Further, the PCF-SPR sensor 102, as disclosed in the present disclosure, is capable of detecting unknown analyte RI even when the sample RI has thechange of about 10⁻⁶ in the sensing range of 1.29 to 1.40. To execute the detection performance and account for the changing structural qualities during manufacturing, the model parameters are altered up to 10% from their intended value. The asymmetric-core guided PCF-SPR sensor 102 is an effective model for point-of-care applications in detecting analytes including, but not limited to, glucose, viruses, DNA/RNA, and proteins, small molecules among other things since it has exceptional sensing qualities with a simple design.

Numerous modifications and variations of the present disclosure are possible in light of the above teachings. It is therefore to be understood that within the scope of the appended claims, the invention may be practiced otherwise than as specifically described herein.

1. A photonic crystal fiber-based surface plasmon resonance (PCF-SPR) sensor to detect a refractive index of an analyte comprising:
a fiber core having:
a first scale-down (SCD) cavity having a first diameter;
a plurality of second SCD cavities each having a second diameter;
a plurality of third SCD cavities each having a third diameter; and
a groove, wherein a surface of the groove is coated with a metal having a first thickness,
wherein the first SCD cavity, the plurality of second SCD cavities, the plurality of third SCD cavities, and the groove extend axially along the fiber core;
an analyte channel having a second thickness, wherein the analyte channel surrounds the fiber core, includes the groove, is exposed to the metal, and is configured to stream the analyte; and
an outer layer surrounding the analyte channel,
wherein the refractive index of the analyte is detected based on an intensity lost by an incident light passing through the PCF-SPR sensor due to dissipation of a plasmonic energy.

2. The PCF-SPR sensor of claim 1, wherein the groove is U-shaped.

3. The PCF-SPR sensor of claim 1, wherein the first diameter is smaller than the second diameter, and the second diameter is smaller than the third diameter.

4. The PCF-SPR sensor of claim 3, wherein the first SCD cavity is located in a center of the fiber core and is configured to facilitate a phase matching of an elementary core mode with a plurality of Surface-Plasmon-Polariton (SPP) modes.

5. The PCF-SPR sensor of claim 4, wherein the plurality of second SCD cavities surrounds the first SCD cavity and the plurality of third SCD cavities surrounds the plurality of second SCD cavities; and
wherein the plurality of second and third cavities are configured to provide an evanescent field in an interface between the surface of the groove and the metal.

6. The PCF-SPR sensor of claim 5, wherein the first SCD cavity and each of the plurality of second and third SCD cavities are separated by a pitch size, wherein the pitch size is a distance between centers of the nearest neighboring first SCD cavity and each of the nearest neighboring plurality of second and third SCD cavities.

7. The PCF-SPR sensor of claim 6, wherein the plurality of second SCD cavities includes six second SCD cavities.

8. The PCF-SPR sensor of claim 7, wherein the metal is gold, and wherein the fiber core is a single-mode fused silica.

9. The PCF-SPR sensor of claim 8, wherein the first thickness is between 40 nm and 50 nm.

10. The PCF-SPR sensor of claim 8, wherein the second thickness is about 1.36 μm.

11. The PCF-SPR sensor of claim 8, wherein the plurality of second SCD cavities has a pitch size of about 2.2 μm.

12. The PCF-SPR sensor of claim 8, wherein the first diameter is about 0.264 μm, the second diameter is about 0.5 μm, and the third diameter is about 1.76 μm.

13. The PCF-SPR sensor of claim 8, wherein the fiber core consists of a single-mode fused silica except for the surface of the groove which is coated with the metal.

14. A system for identifying an analyte, comprising:
a light source;
a PCF-SPR sensor connected to the light source, wherein the PCF-SPR sensor comprises:
a fiber core having:
a first SCD cavity having a first diameter;
a plurality of second SCD cavities each having a second diameter;
a plurality of third SCD cavities each having a third diameter; and
a groove, wherein a surface of the groove is coated with a metal having a first thickness,
wherein the first SCD cavity, the plurality of second SCD cavities, the plurality of third SCD cavities, and the groove extend axially along the fiber core,
an analyte channel having a second thickness, wherein the analyte channel surrounds the fiber core, is in contact with the metal, and is configured to stream the analyte; and
an outer layer surrounding the analyte channel;
wherein the refractive index of the analyte is detected based on an intensity difference between incident light entering the fiber core and the incident light dissipated in the fiber core as plasmonic energy;
an optical spectrum analyzer connected to the PCF-SPR sensor; and
a computer connected to the optical spectrum analyzer configured to analyze a loss curve obtained by the optical spectrum analyzer to identify the analyte.

15. The system of claim 14, wherein the groove is U-shaped.

16. The system of claim 14, wherein the first diameter is smaller than the second diameter, and the second diameter is smaller than the third diameter.

17. The system of claim 16, wherein the first SCD cavity is located in a center of the fiber core and is configured to facilitates a phase matching of an elementary core mode with a plurality of Surface-Plasmon-Polariton (SPP) modes.

18. The system of claim 17, wherein the plurality of second SCD cavities surrounds the first SCD cavity and the plurality of third SCD cavities surrounds the plurality of second SCD cavities; and
wherein the plurality of second and third cavities are configured to provide an evanescent field in an interface between the surface of the groove and the metal.

19. The system of claim 18, wherein the first SCD cavity and each of the plurality of second and third SCD cavities are separated by a pitch size, wherein the pitch size is a distance between centers of the nearest neighboring first SCD cavity and each of the nearest neighboring plurality of second and third SCD cavities.

20. The system of claim 19, wherein the plurality of second SCD cavities includes six second SCD cavities.
